(19) United States
(12) Patent Application Publication
(10) Pub. No.: US 2021/0185947 A1
(43) Pub. Date: Jun. 24, 2021

(54) Vertically Mounted Cropping And Irrigation System

(71) Applicant: AgStack, Inc., Berkeley, CA (US)

(72) Inventor: Jonah Crawford, Berkeley, CA (US)

(73) Assignee: AgStack, Inc., Berkeley, CA (US)

(21) Appl. No.: 16/761,870

(22) PCT Filed: Nov. 6, 2018
(86) PCT No.: PCT/US2018/059400

§ 371 Date: May 6, 2020

Related U.S. Application Data
(60) Provisional application No. 62/582,078, filed on Nov. 6, 2017.

(51) Int. Cl. A01G 27/00; A01G 9/02; G05B 15/02

(52) U.S. Cl. CPC A01G 27/003; G05B 15/02; A01G 9/023

(57) ABSTRACT

In one embodiment, the present disclosure relates to a vertically oriented plant growth system (2) that includes a plurality of tower arrays, each tower array having a plurality of towers. Each tower is vertically mounted and includes a plurality of hub structures thereon for growing crops. The individual hub structures include attached bottles that are sized to support soil sufficient for plant growth and prevent the escape of water. Through the supply of pressurized water to flow control devices above each tower of the tower arrays, soil in each bottle is irrigated with water received at a controlled flow rate to grow crops using minimal space and without reliance on particular soil conditions.

### CROSS-REFERENCE TO RELATED APPLICATIONS

This application claims the benefit of the filing date of U.S. Provisional Patent Application No. 62/582,078 filed Nov. 6, 2017, the disclosure of which is hereby incorporated herein by reference.

### BACKGROUND OF THE INVENTION

With world population expected to continue to increase dramatically over the coming decades, the strain on existing land used for cultivation of crops will continue to increase. Exacerbating this trend, as incomes increase in developing countries, demand for protein rich foods also increases, and production of such foods requires resources above and beyond those required for other types of food. In view of these developments, the need for sustainable approaches to cultivation is only set to increase to fulfill the demand that cannot otherwise be met, as a practical matter, by existing arable land.

Moreover, in addition to land, concerns continue to increase regarding the efficiency of crop cultivation and the quality of harvested crops. Existing approaches may expose crops to contaminants in the soil, excessive pesticides, or may provide too much or too little water to achieve optimal growth.

One approach that has been adopted in an effort to address at least some of these concerns, such as improved use of energy and water, is the use of aeroponics, a form of cultivation that involves the application of misters to the roots of plants. With aeroponics, soil is removed from the cultivation process. And, without soil, greater plant density is achieved. However, due to the lack of soil, plants grown with aeroponics lack beneficial growth promoting bacteria and mushrooms, which would otherwise burrow into the roots of plants and provide a slow drip of highly bioavailable molecules that feed the plants. Thus, the plants are unable to achieve flavor and nutritional quality that a rich soil is able to provide. Moreover, without soil, such techniques cannot provide the living biomes, e.g., living organisms in soil, that more fully express plant phenotypes which genetically program the plant to withstand greater environmental stress (i.e. drought, high-heat, predation).

Another difficulty relating to the sustainability of current practices lies in the inability to recycle certain materials in many regions of the world, leading to excess waste. Indeed, many nations around the world lack the industrial capability to collect and recycle plastic soda bottles. Accordingly, billions of such bottles accumulate in the environment of such nations each year. The problems resulting from a lack of recycling capability are compounded by the methods used for disposal of bottles where such circumstances exist. In the absence of plastics recycling facilities, methods of plastic bottle disposal include unsustainable techniques such as use of open-pit fires, dumping in landfills and dumping into waterways and the ocean.

Widespread difficulties relating to a lack of facilities for recycling plastic bottles is well documented. Indeed, many regions lack the ability to recycle. In a report entitled The New Plastics Economy: Rethinking the Future of Plastics, Ellen MacArthur Foundation, 2016, the difficult circumstances surrounding the disposal of plastics in developing nations is identified as an ongoing environmental concern. The report outlines specific issues with disposal in developing countries including combustion of plastic bottles without proper controls and the broader problem that approximately 12 million tons of plastic waste is disposed of in the oceans each year.

Nations which lack the industrial capacity to collect and recycle plastic soda bottles also often lack sufficient food security and rely on food imports and food donations from abroad to feed their populations. The United Nations Least Developed Countries Registry lists forty-one countries which are food insecure in that they rely on subsistence agriculture, experience difficulty feeding their populations and must import large quantities of food to feed their populations. By the same measure many of these countries, especially those in tropical regions, are experiencing deforestation due to their populations attempt to create additional farmland. These attempts are often a result of a lack of knowledge and resources to effectively use existing farmland. As a result, such countries are inadequately equipped to ensure farming is performed in a sustainable manner.

The causal relationship between subsistence agriculture, soil degradation and slash and burn deforestation is well documented. For instance, such causal relationship is described in Kissinger et al., Drivers of Deforestation and Forest Degradation: A Synthesis Report for REDD+ Policymakers, Lexeme Consulting, Vancouver Canada, August 2012. The report notes that where subsistence agriculture is prevalent, existing intact undisrupted native forests, often habitats for rare or endangered species, are cut down or burned to make available new soils following the abandonment of poorly managed soils on adjacent plots. Additionally, the Drivers of Deforestation report estimates that agriculture is the main driver for eighty percent of de-forestation worldwide.

Another challenge faced by nations reliant on subsistence agriculture is that farmers must travel significant distances to both markets and sources of water. In some countries, the need for families to travel many kilometers to carry water for crops and household activities is a primary contributing factor to security concerns. Thus, the inability of certain nations to collect and recycle plastic and their reliance on substance agriculture presents both environmental and personal security related challenges.

Accordingly, a need exists for sustainable farming techniques that can be performed efficiently and produce high quality products. Additionally, a need exists for farming techniques that can be performed with readily available materials and minimal resources so that such techniques may be used even in the most challenging environments.

### BRIEF SUMMARY OF THE INVENTION

The present disclosure generally relates to modular, vertically mounted, plastic bottle based or other plastic receptacle based systems adapted for use in growing plants and/or crops and providing irrigation and fertigation for such plants and/or crops. These systems are also referred to as plant growth systems.

The systems as described herein and their methods of use provide many advantages relative to existing approaches to horticulture and agriculture. For instance, the systems of the disclosure minimize the hours of labor required to manage a particular volume of crops in view of the smaller space required to grow and harvest such crops. Also, because the plants are positioned vertically in the systems of the disclosure, any manual labor associated with management of crops is less likely to result in injury from bending over repeatedly. The system is also versatile in that it may be employed either indoors or outdoors, and for outdoor applications, it is not contingent on the arability of the available land. Thus, through the use of the contemplated systems, land that may be put to productive use is increased dramatically compared to traditional farming methods.

Further, plants grown on towers of the plant growth systems are modular and easy to transport to consumers. Because the land required to operate the contemplated systems is much less than that required for traditional farming techniques, the plant growth systems may be located closer to or within urban areas, reducing costs associated with shipping and also making it easier to bring fresh produce to market due to the reduced time and distance required to transport a harvest from the site of the system to retail outlets.

Another advantage of the plant growth system is its water efficiency. The contemplated systems have nominal water waste, a result made possible through various innovations. For example, in systems where water is distributed to plants in the system at a controlled flow rate, the flow rate is adjustable to match the transpiration rate in the downstream plants, so that no excess water is provided to the plants. As described in particular embodiments, data collection devices may be incorporated into the system to closely monitor water levels in each plant so that adjustments may be made for the maintenance of equilibrium, if required. In contemplated gravity based systems, water is recycled and treated in a cyclic loop to minimize waste. A related advantage resulting from nominal waste water is that less water overall is required to irrigate plants of the system. Indeed, the contemplated systems may operate with up to 99% less water than that used in traditional agriculture reliant on soil-based plants and/or crops.

Another advantage of the contemplated systems is their adaptation to be accompanied by fertigation equipment so that nutrients may accompany water distributed to the plants for nourishment and other treatment. This feature enhances soil quality and control of the nutrient cycle. Further, because the system is above ground and not exposed to ground soils, there is a substantial reduction in risk of disease or damage to the crops compared to traditional ground soil based crops. Additionally, provision of nutrients through above ground fertilization reduces the overall nutrients required for the plants compared to traditional crops.

In one embodiment, a cropping and irrigation system includes one or more towers, each tower having a plurality of hub structures disposed thereon in a vertically oriented manner. The hub structures are suspended from above by rope and in this way several hub structures form a column hung together by the same rope. A system according to this embodiment may have two or more columns of hub structures. Each hub structure is supplied with water through tubes connected to a pump located near the frame, the pump receiving and pumping water from a water source.

Within each hub structure are open-bottomed plastic bottles filled with soil. Water pumped from the pump enters the hub structure at an emitter which controls the flow rate of water through to the hub structure and into the open-bottomed plastic bottles. A nylon wick or other means capable of capillary action to carry water can be included so that water may travel from an inlet to the hub structure to the soil.

The system reduces crop risk in several important ways. First, suspension of the crops in a frame reduces vectoring of soil borne pathogens. Put another way, negatively indicated pathogens typically reach plants through the roots of plants in soil. However, with soil for plants suspended in a frame of the systems described herein, a means of soil management is provided in that inputs into the soil are controlled and are above ground, mitigating the susceptibility of plants to diseases. Thus, soil used for crop production may be carefully managed to reduce crop risk in the systems contemplated herein. Similarly, suspension of the crop enables easy application of a protective netting which can prevent pests from crawling or flying onto crops.

The system is environmentally friendly in several respects. For example, the use of readily available materials that would otherwise need to be disposed of reduces waste while improving farming yields and reducing crop risks presented by predation and the vector of ground based soil plant pathogens. Similarly, such materials allow for the assembly and placement of the system without the need for heavy equipment at the placement site. The vertical structure takes up minimal surface area on the ground, and therefore more crops can be grown and irrigated than would otherwise be possible over a similar area using traditional farming or basic subsistence farming techniques. Additionally, it is possible for a single individual to set up, operate and maintain the system.

In one embodiment, the present disclosure relates to a vertically oriented plant growth system that includes two towers, a liquid source, a flow control device and a tube. Each of the two towers is adapted for mounting over a ground surface and includes a central pipe and a plurality of hub structures. The central pipe is oriented normal to the ground surface and is supported by either an above ground frame or an extension through the ground surface functioning as a foundation. The plurality of hub structures are attached to the central pipe and spaced at intervals along the central pipe, each hub structure including at least one container attached thereto sized for the disposal of soil sufficient to grow a plant. Returning to the system components, the liquid source is adapted to hold liquid and includes a pump. The flow control device with output tubes extends to an input valve on each of the plurality of hub structures. The tube is connected to the source and to the flow control device. The pump is configured so that when it is activated, liquid is distributed downstream from the source through the tube and through the flow control device such that the liquid reaches soil disposed in each container at a predetermined flow rate.

In other embodiments, each tower of the tower array also includes a data collection device positioned on the central pipe above all hub structures on the tower. The data collection device is adapted to collect data associated with conditions of the soil and plant in each container on one side of an adjacent tower. In yet another embodiment, the data collection device also includes sensors adapted to detect additional data collection devices on adjacent towers so that a relative position of each data collection device is established.

In another embodiment, the present disclosure relates to a vertically oriented plant growth system that includes a first tower array with two towers and a second tower array with two towers. The tower arrays are oriented so that a single axis that passes through the two towers of the second tower array is parallel to a single axis that passes through the two towers of the first tower array. Each tower of the first and second tower arrays includes a central support structure that extends upward from a ground surface. Further, each tower also includes a plurality of hub structures with one or more bottles or suitable planters attached, each hub structure attached to the central support structure and spaced from an adjacent central support structure. Finally, each tower also includes a data collection device positioned above the plurality of hub structures at a predetermined distance from the ground surface. The data collection devices are operable to collect location data regarding each tower through communication between sensors on each data collection device. Moreover, the data collection devices are operable to collect data regarding contents of the bottles or planters on each tower through image data collected from images captured by an electronic device within the data collection devices.

In another embodiment, the present disclosure relates to a vertically oriented plant growth system that includes a tower, a flow control device, and an enclosed channel. The tower is adapted for mounting over a ground surface and includes a central support structure and a plurality of hub structures. The central support structure is oriented generally perpendicular to the ground surface, the central support structure supported by either an above ground frame or an extension through the ground surface functioning as a foundation. The plurality of hub structures are attached to the central support structure and are spaced at intervals along the central support structure. Each hub structure includes at least one container attached thereto sized for the disposal of soil sufficient to grow a plant. The flow control device includes output tubes extending to an input valve on each of the plurality of hub structures. The enclosed channel is in fluid communication with a source of liquid under pressure and the flow control device. When the liquid is distributed downstream from the source through the enclosed channel and then into and through the flow control device, the liquid dispenses into soil disposed in each container at a predetermined flow rate.

In some embodiments, the flow control device is mounted above the plurality of hub structures. In other embodiments, the enclosed channel is directly connected to the central support structure such that pressurized liquid received in the enclosed channel travels downstream through the central support structure and into the flow control device. In still further embodiments, the enclosed channel is directly connected to the flow control device. In some examples of the aforementioned embodiment, the central support structure is rotatable about its axis and rotation of the central support structure does not transfer forces to the enclosed channel. In further examples, the system also includes a rotary union attached to the flow control device opposite the central support structure such that the flow control device separates the rotary union and the central support structure. In this arrangement, the flow control device and the central support structure are adapted to rotate in unison.

In some embodiments, the system also includes a second tower adapted for mounting over a ground surface. The second tower includes a second central support structure oriented generally perpendicular to the ground surface and is supported by either an above ground frame or an extension through the ground surface functioning as a foundation. The second tower also includes a second plurality of hub structures attached to the second central support structure that are spaced at intervals along the second central support structure. Each hub structure includes at least one container attached thereto sized for the disposal of soil sufficient to grow a plant.

In some examples of the aforementioned embodiment, the system also includes a valve located on the enclosed channel upstream of each of the two towers. The valves in this arrangement are independently actuatable to control flow of pressurized liquid into either one or both of the two towers. In other examples, the system also includes a second flow control device positioned above all of the hub structures of one of the two towers while the first flow control device is positioned above all of the hub structures of the other of the two towers. In still further examples, the first flow control device is configured to regulate liquid output to a first flow rate and the second flow control device is configured to regulate liquid output to a second flow rate. In other examples, each tower further comprises a data collection device positioned on the central pipe above respective flow control devices, the data collection device adapted to collect data associated with conditions of the soil and plant disposed in each container on an adjacent tower. In still further examples, the data collection devices further comprise infrared sensors such that each data collection device is adapted to communicate with the other to establish a position of each. And in still further examples, the data collection devices also include a camera adapted to capture image data of each container on an adjacent tower.

In another embodiment, the present disclosure relates to a system that includes a first tower array having three towers and a second tower array having three towers. Each tower within the first and second tower arrays includes a central support structure, a plurality of hub structures that are each centered on the central support structure and spaced apart from one another, and a flow control device positioned above the plurality of hub structures, the flow control device including eight outputs each with distribution tubes attached thereto. Each of the plurality of hub structures includes an input valve connected to one of the eight distribution tubes. Further, the flow control device is configured to receive liquid and distribute the liquid to each planter attached to the hub structure on the tower. An alignment of the towers is as follows. The three towers of the first tower array are aligned with one another such that a first axis passes through the central support structure of each, while the three towers of the second tower array are aligned with one another such that a second axis passes through the central support structure of each, the second axis parallel to the first axis. The relationship between the towers is such that a third axis perpendicular to the first axis and passing through one of the three towers of the first tower array also passes through one of the three towers of the second tower array.

In some embodiments, each tower further comprises a data collection device positioned on the central pipe above the flow control device, each data collection device being positioned at the same elevation so that infrared sensors on any one data collection device are in communication with infrared sensors on another data collection device. In other embodiments, the data collection device is adapted to run a self calibration protocol so that a location of each tower relative to a reference tower is established. In further embodiments, each data collection device further comprises six cameras, each camera positioned facing a different direction such that image data on planters positioned on each tower is retrievable, the image data being associated with conditions of the soil and plant in each container. In some examples of the aforementioned embodiment, the image data is associated with a direction the camera faces and the tower housing the camera.

In another embodiment, a vertically oriented plant growth system includes a first tower array including two towers and a second tower array including two towers. The arrays are arranged such that a single axis through the two towers of the second tower array is parallel to a single axis through the two towers of the first tower array. Each tower of the first and second arrays includes a central support structure extending upward from a ground surface, a plurality of hub structures and a data collection device. The plurality of hub structures include one or more attached planters and each is attached to the central support structure and spaced from an adjacent central support structure. The data collection device is positioned above the plurality of hub structures at a predetermined distance from the ground surface. Returning to the overall system, the data collection devices are operable to collect location data regarding each tower through communication between sensors on each data collection device. Moreover, the data collection devices are operable to collect data regarding contents of the planters on each tower through image data collected from images captured by an electronic device within the data collection devices.

In yet another embodiment, a vertically oriented plant growth system includes a tower, a body and a pump. The tower includes a central support structure, a plurality of hub structures, a flow control device, a plurality of distribution tubes, and a plurality of collection tubes. Each of the hub structures is centered on the central support structure and spaced apart from one another and includes a plurality of planters attached thereto. At least one of the planters has soil or a hydroponic growth medium disposed therein. Each distribution tube is connected to one of the plurality of outputs of the flow control device at one end and a valve of one of the plurality of hub structures at an opposite end. Each collection tube connected to an opening in one of the planters at one end and a central valve at an opposite end. The body is adapted for receiving liquid downstream of central valve and for filtering such liquid. The pump is adapted to receive liquid treated by the body and to distribute pressurized liquid to the central support structure. When pressurized liquid flows downstream from the pump, liquid is pumped through the central support structure into the flow control device and then distributed separately into individual hub structures and the planters attached thereto such that any liquid not absorbed by soil in the planters flows downstream by gravity into collection tubes and returns to the body when the central valve is open.

In another aspect, the present disclosure relates to a method of irrigating plants. The method according to one embodiment involves providing pressurized liquid to a tower with a structure that includes a central support structure, a plurality of hub structures and a flow control device. Each of the hub structures is centered on the central support structure and spaced apart from one another. Further, each hub structure includes a plurality of planters attached thereto, at least one of the planters having soil or a hydroponic growth medium disposed therein. The flow control device, connected to the central support structure, is positioned above the plurality of hub structures and includes a plurality of outputs each with distribution tubes attached thereto. During the providing step, liquid travels through the central support structure to the flow control device; the flow control device outputs received liquid to individual hub structures at a predetermined flow rate; and the liquid received in the hub structures travels into soil within each planter attached to the hub structure.

In some embodiments, the method also involves providing liquid to the first tower, to a second tower, or to both through the control of a valve positioned on the liquid flowpath upstream of the central support structure of at least one tower. In other embodiments, the method also involves communicating between the first tower and the second tower to determine a relative position of each tower through a data collection device positioned above respective flow control devices on each tower.

### BRIEF DESCRIPTION OF THE DRAWINGS

A more complete appreciation of the subject matter of the present disclosure and of the various advantages thereof may be realized by reference to the following detailed description in which reference is made to the accompanying drawings in which:

FIG. 1 is a perspective view of a plant growth system including multiple tower arrays according to an embodiment of the disclosure.

FIG. 2 is a top view of the plant growth system of FIG. 1.

FIG. 3A is a side view of certain features of the plant growth system of FIG. 1.

FIG. 3B is a side view of certain features of a plant growth system according to an embodiment of the disclosure.

FIGS. 4-6 are various views of various features of a hub structure of the plant growth system of FIG. 1.

FIG. 7A is a side view of a foundation included as part of the plant growth system of FIG. 1.

FIG. 7B is a side view of a foundation included as part of the plant growth system of FIG. 3B.

FIG. 8 is a side view of a single tower of a plant growth system according to an embodiment of the disclosure.

FIG. 9 is a perspective view of a hub structure of the plant growth system of FIG. 8.

FIG. 10 is a side view of a plant growth system according to an embodiment of the disclosure.

FIG. 11 is a perspective view of a hub structure of the plant growth system of FIG. 10.

FIG. 12 is a perspective view of a plant growth system according to an embodiment of the disclosure.

FIGS. 13-14 is a perspective and side views of a data collection device of a plant growth system according to an embodiment of the disclosure.

FIG. 15 is a top view of the plant growth system of FIGS. 13-14.

FIG. 16 is a partial side view of the plant growth system of FIGS. 13-14.

FIG. 17 is a flow chart of a method of operating a plant growth system according to an embodiment of the disclosure.

FIG. 18 is a flow chart of a method of operating a plant growth system according to another embodiment of the disclosure.

### DETAILED DESCRIPTION

The present disclosure relates to apparatuses, systems and methods for growing and irrigating crops vertically using minimal resources while concurrently leaving a minimal environmental impact through the implementation of the technology.

In one aspect, a plant growth system includes structure to plant, grow and harvest plants and crops through a controlled supply of nutrients, e.g., through fertigation, and through controlled irrigation. As referenced herein, “plant growth system” refers to an overarching system to grow and harvest plants and/or crops, along with all accompanying parts, components or non-tangible technologies used to complement and otherwise improve these functions.

More specifically, the plant growth system of the first aspect includes one or more tower arrays, each tower array including one or more towers. Each tower includes a plurality of hub structures spaced along a height of the tower. When a tower array includes at least two towers, a totality of the hub structures define multiple rows, each across the series of towers and multiple columns based on each individual tower. As will be apparent through this description, the arrangement of hub structures in ordered rows and columns is an advantageous feature of the system. Each of the hub structures is vertically adjustable and includes a plurality of receptacles mounted thereon for storage of soil, a hydroponic medium, or other materials capable of providing nutrients to crops and plants. The receptacles included in the system may be planters, bottles, or other containers. It should be appreciated that the bottles included in the specific embodiments of the systems and methods described herein may be substituted with other receptacles, such as planters. In this manner, any type of receptacle mentioned in the embodiments of this disclosure may be substituted with another type of receptacle. The receptacles used are advantageous in that they are rigid and have structural properties that can support plants disposed therein throughout the expected lifecycle of such plants. Each tower is positioned above a ground surface and extends upward in a vertical direction. The term “vertical” as used in this disclosure refers to an axis extending either toward or away from a ground surface. Such axis need not be at a right angle to a ground surface.

The plant growth system is configured to irrigate and/or fertilize the contents of the receptacles (e.g., planters or bottles) through the provision of liquid typically in the form of water. Throughout this disclosure, the term liquid refers to water alone, water in combination with fertilizer, water in combination with other nutrients, or other liquids with our without supplements used to irrigate and promote growth in plants and crops. Hereafter, any reference to “liquid” encompasses each of the foregoing.

### Outdoor Systems with Pressurized Liquid Flow

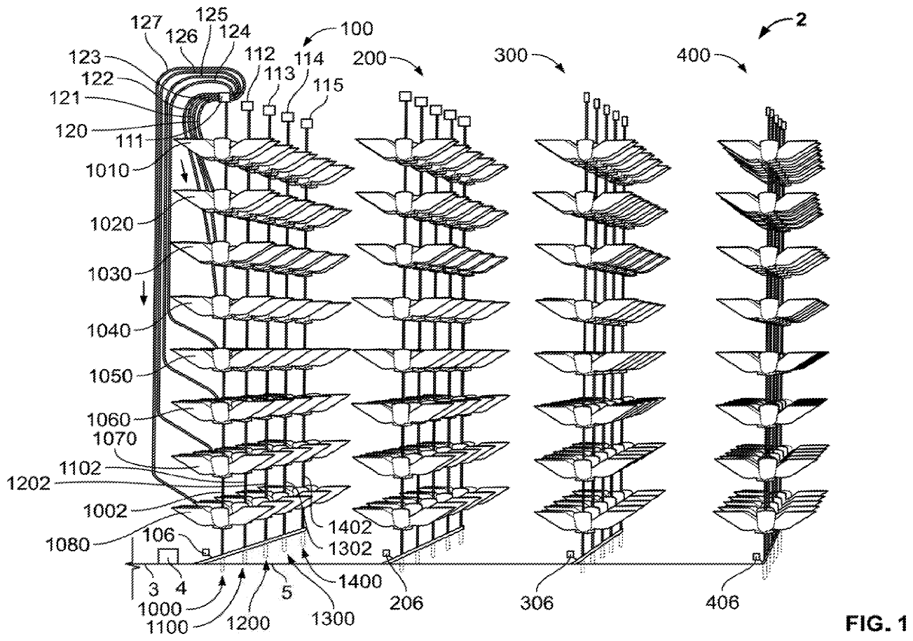

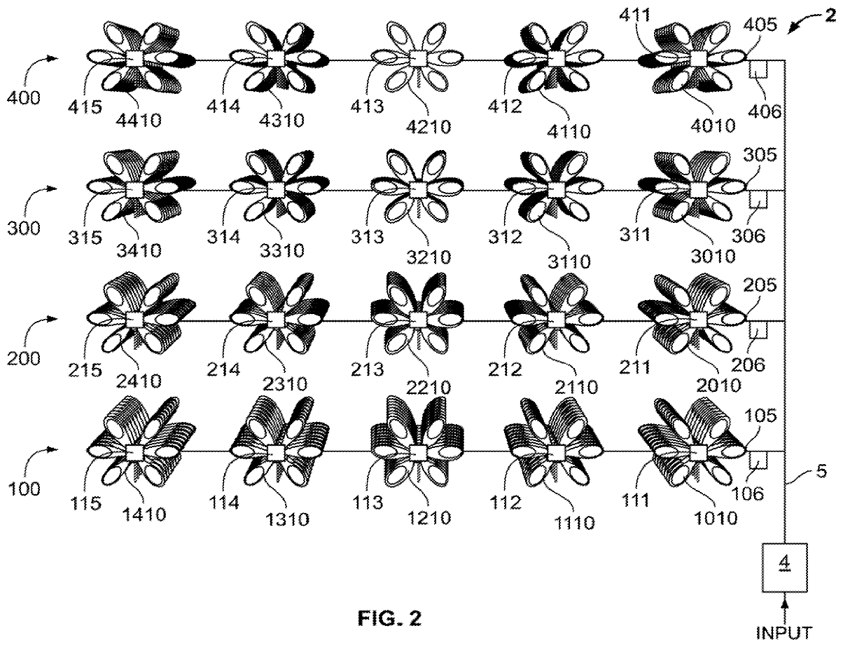

FIGS. 1 and 2 illustrate one embodiment of a plant growth system 2 that includes a plurality of tower arrays 100, 200, 300, 400, where each tower array includes five towers. For example, tower array 100 includes towers 1000, 1100, 1200, 1300 and 1400. Of course, the exact number of towers within each tower array may be varied to suit a particular horticultural application or available space.

Tower array 100 will now be described in detail. A description of other elements included in the plant growth system relating to the transmission of liquid into bottles or planters mounted on the tower arrays will follow separately. Tower array 100 includes eight rows and five columns of hub structures. The rows are best shown in FIG. 2 while the vertically oriented columns, i.e., towers, are best shown in FIG. 1. Each row or column of the tower array includes a series of hub structures. For example, a column defined by tower 1000 includes eight hub structures 1010-1080.

Because the plant growth system is arranged vertically, it occupies a minimal amount of surface area on the ground below, and certainly much less than what would be required if each plant were positioned at ground level. In this manner, the system provides an advantage in that it promotes forest preservation because the need to clear forest or use available land is minimized relative to other cropping and irrigation approaches. Further, when the system is located near a population center, a total number of man hours required to cultivate crops such as nutritional and cash crops is reduced. Additionally, placement of tower array 100 (and other tower arrays) above ground not only minimizes space needed for a given crop volume, but also improves underlying soil quality, as placement of the tower array components above ground prevents soil contamination and promotes the regenerative process in the soil. Yet another advantage of the vertical arrangement of the system is that has improved flood resistance relative to traditional horticultural or agricultural techniques.

Turning to tower 1000 and hub structure 1010 thereon, it should be noted that tower 1000 and hub structure 1010 are representative and that other towers and hub structures in tower array 100 and towers and hub structures in tower arrays 200, 300, 400 have similar features.

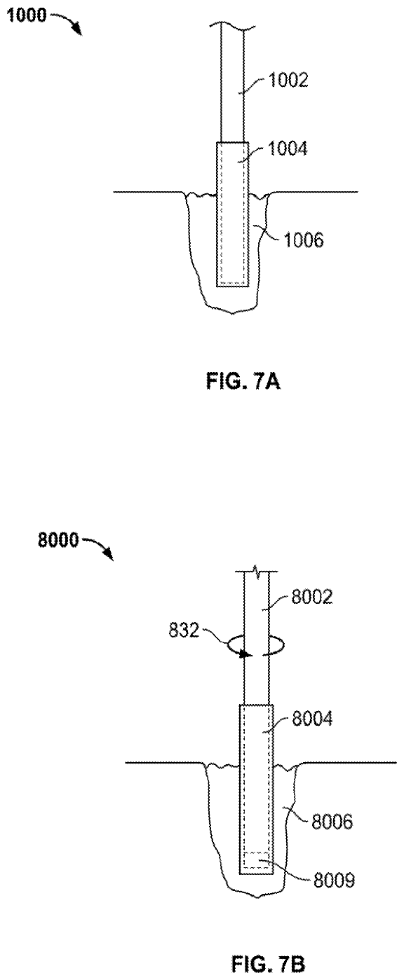

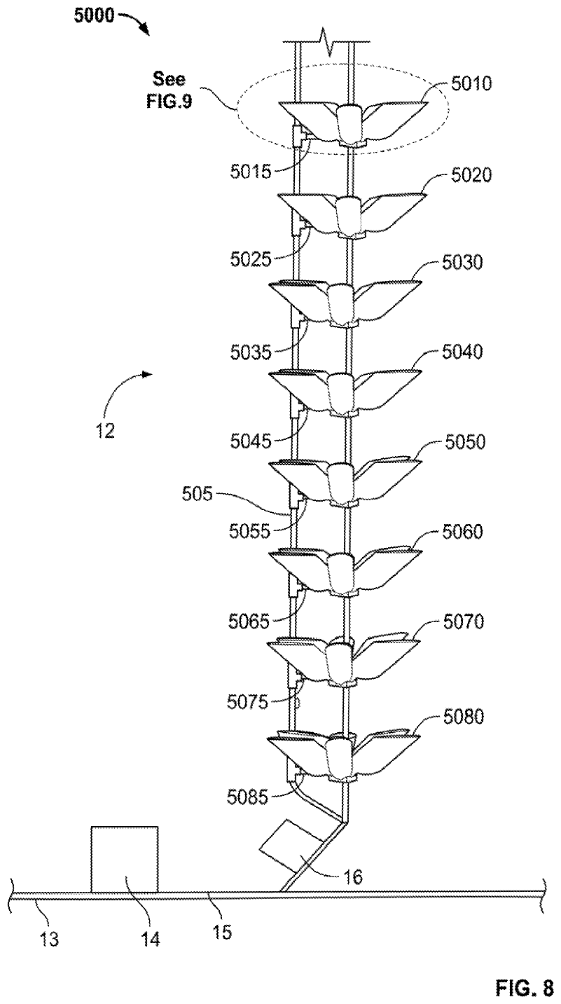

Tower 1000 includes eight hub structures 1010-1080, positioned at intervals over a height of a central support structure. In system 2, the central support structure is a central pipe 1002 that forms a principal structural support for the tower. In some examples, the central pipe is hollow, made of galvanized steel, and is ½ inches in diameter. A hollow tube of galvanized steel is advantageous for at least the reason that it provides rigidity sufficient to hold up a tower while resisting corrosion which can be particularly beneficial as tower 1000 may often be used in humid environments and/or outdoors exposed to the elements. A size of the central pipe may vary significantly as a function of how much load it bears and whether it serves any other purpose. In other examples, the central pipe may be ⅝, ¾ or 1 and ½ inches in diameter. In further examples, other metals may be used. In still other examples, the central support structure may be bamboo, a metal rod or may be fashioned from wood or other natural material, or any combination of materials. In these examples, a hub base of the hub structure may be modified to accommodate the central support structure. When the support structure is a metal rod, it may be sourced from used or recycled material such as rebar typically used for concrete reinforcement. Metal rods are typically preferred for their strength and relative ample availability throughout the world. In some examples, the rods are threaded. It should be appreciated that some central support structure materials may call for a different structural foundation than that provided for tower 1000 and shown in FIG. 7A, and that such foundation will have a design commensurate with the load it bears and the expected shear force or flexure.

As shown in FIG. 7A, central pipe 1002 is fitted within a sleeve 1004 securely positioned in the ground below the tower. In turn, sleeve 1004 is fixed in the ground with an epoxy foam 1006 and is set in place when the foam is cured. In one example, the foam is a polyurethane foam and the sleeve is placed at a depth of thirty inches. A depth of the sleeve under the ground surface is sufficient to provide support for the tower against expected loading on the tower during use. The controlling load for the design of the pipe and foundation is typically wind load, though specific conditions at the placement site of the plant growth system should be considered to determine whether other factors dictate design loads. Towers 1100, 1200, 1300 and 1400, along with the towers of tower arrays 200, 300 and 400, all utilize central pipes and have similar foundations. This support configuration is primarily suited for outdoor applications of the system, and is advantageous for such purpose as it provides structural support for the system without the need for additional supporting elements to hold up the towers. Of course, in variants, additional pipes or other structures may be bridged between towers or extended from the ground at an angle to attach to one or more towers to provide extra support when desired.

Turning to the hub structures of tower 1000, hub structure 1010 is representative of hub structures 1020-1080, and indeed of the forty hub structures in tower array 100 depicted in FIG. 1. However, as will be explained, each hub structure may be varied to suit conditions or the particular plant(s) and/or crop(s) planted in the containers. Indeed, the particular configuration of any one hub structure may vary from the others as a matter of operational expediency, material availability, or the desire of the individual or individuals constructing the tower array(s). Further, each hub structure is adjustable either along a height of the central pipe or through rotation of the hub structure about a longitudinal axis of the central pipe, described in greater detail below.

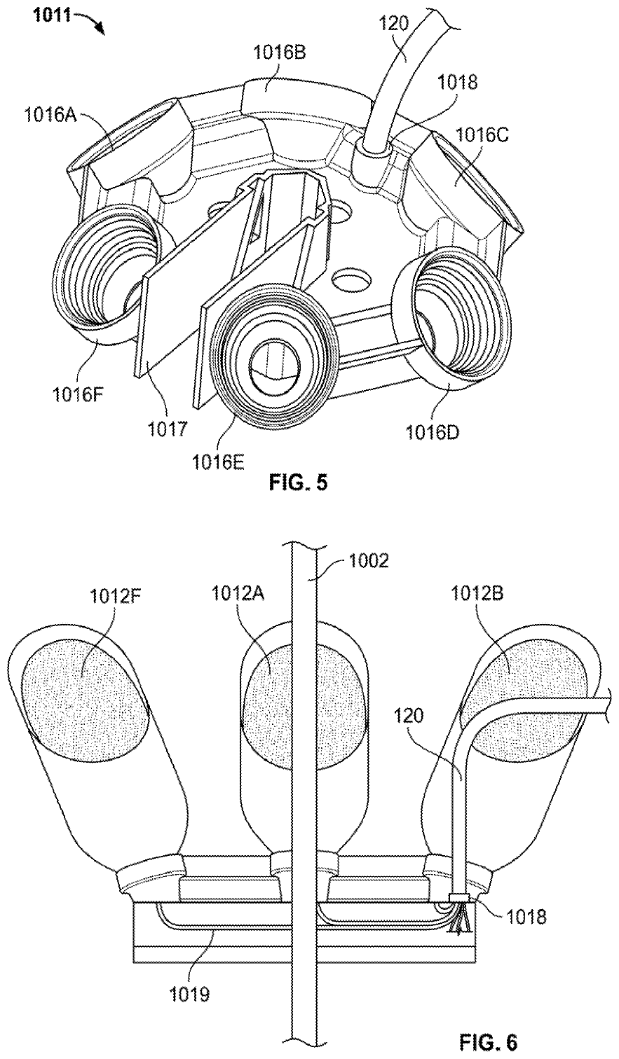

FIGS. 4-6 illustrate greater detail respecting hub structure 1010. Hub structure 1010 includes hub base 1011 and six bottles 1012A-F, each adapted to hold soil 1014A-F therein. In variants, the hub structure may include greater or less than six bottles or suitable planters as a matter of design choice. As shown in FIG. 4, hub base 1011 is attached to central pipe 1002 via an engagement feature (not shown) within slot 1017. Through the engagement feature, hub base 1011 is configured for disengagement and reengagement with central pipe 1002 to allow for ease of adjustment of a position of the hub base. Hub base 1011 includes six sides, each having two engagement features 1016A-F extending therefrom. As shown, these engagement features are in the form of threaded ports. Each of the engagement features is generally equally spaced from the others and is angled upward at a forty five degree angle. Of course, the angle may be customized as a matter of design choice. Attached to each engagement feature 1016A-F is a corresponding bottle 1012A-F via a threaded cap on each bottle. Each bottle is angled relative to the hub base to the same extent as the engagement features. In one example, the bottles are thirty two ounces in volume and are cut open at an angle toward a bottom end, as shown in FIG. 4. Hub base 1011 also includes valve 1018, adapted for attachment of a tube thereto. Further detail on how valve 1018 is in fluid communication with liquid input into plant growth system 2 is described in greater detail below. Internally within hub base 1011 are enclosed pathways 1019 so that any input into valve 1018, such as a liquid, is directed to each of bottles 1012A-F attached to the hub base. In this manner, any liquid directed into valve 1018 is distributed to plants within each bottle 1012A-F.

Each hub structure is adapted to be rotatable and/or vertically adjustable on the tower to which it is attached. Slot 1017 includes engagement features adapted so that hub base 1011 is rotatable about central pipe 1002. Features in the slot may provide for a locking mechanism to be actuated for disengagement, or may allow for a rotational degree of freedom during use. Plant growth system 2 is configured so that hub base 1011 is detachable from central pipe 1002 and reattachable at the same or another location on its height as desired. In this manner, hub structure 1011 is rotatable and vertically adjustable relative to a respective central pipe. Such adjustability allows the system to be tailored to specific conditions at a site, where individual hub structures or multiple hub structures together may be positioned and oriented to suit the unique conditions at the site. Thus, in another example, a series of hub structures on a tower and attached to a central pipe may be rotated together through a single rotation of the central pipe

Turning to the structure of the plant growth system that provides for liquid transmission to the soil in the containers, and as shown in FIGS. 1 and 2, plant growth system 2 includes a hollow tube 3 structured to connect to a liquid source (not shown) at a first end and a pump 4 at a second end. The pump may be any pump that is readily available. Typically, the pump will use energy that requires minimal external input. For example, the pump may be solar or bicycle powered. Moreover, it is contemplated that other sources of positive liquid pressure may be used in place of a pump. Downstream of pump 4 is tube 5, which is in fluid communication with at least tower array 100, and as illustrated, with each of tower arrays 100, 200, 300, 400 of system 2. Tubes 3, 5 may be any shape or material composition deemed suitable to safely transport liquid such as water through system 2. For example, the tubes may be PVC pipe. Other hollow structures known to those of ordinary skill are also contemplated for use as a substitute for PVC pipe.

As shown in FIG. 1, a valve 106, 206, 306, 406 controls liquid flow into each tower array 100, 200, 300, 400 from tube 5. This allows the liquid flow in plant growth system 2 to be controlled so that liquid may be provided to certain tower arrays and not others. Similarly, a flow path of tube 5 between pump 4 and one or more of the tower arrays may be uninterrupted without any valve in between. In this manner, liquid flow may be simplified through the inclusion of a minimal number of valve locations in system 2. The valves may be any type typically used to control liquid flow. In one example, the valves are solenoid valves. The valves may be controlled at their placement location or remotely, as described in greater detail below.

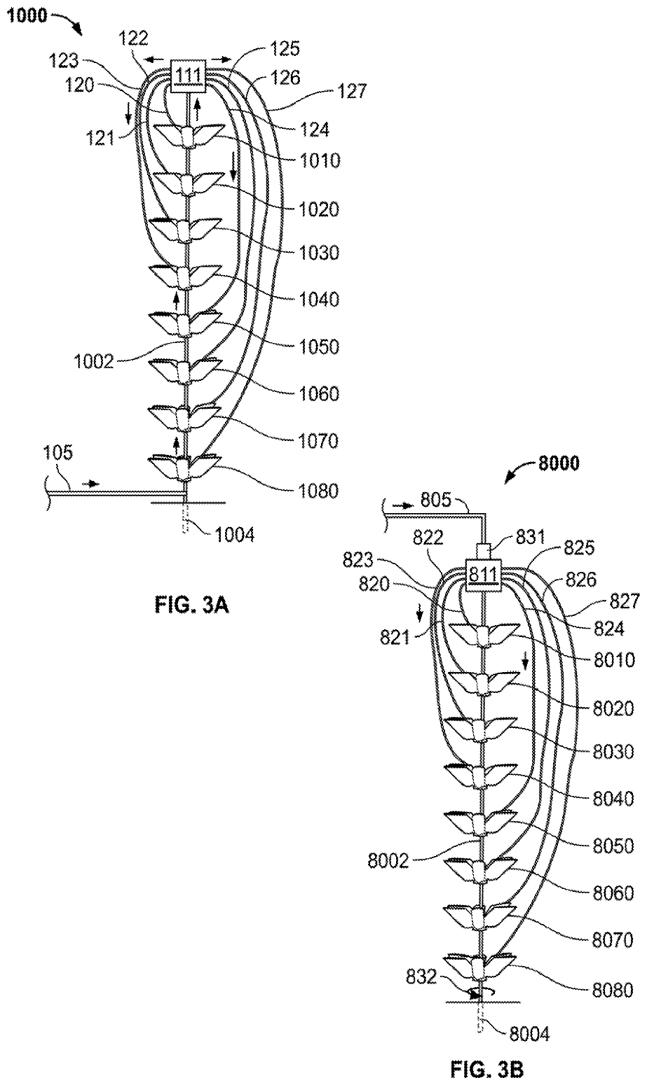

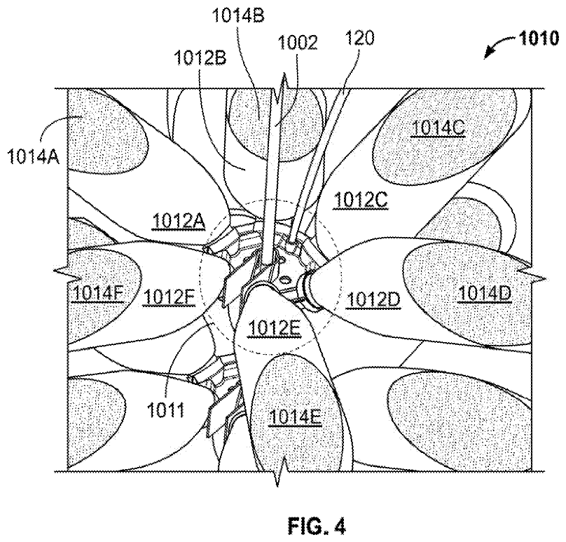

Downstream of each valve 106, 206, 306, 406, is another tube. For tower array 100, this is tube 105. Tube 105 extends from valve 106 to a series of central pipes supporting respective towers 1000, 1100, 1200, 1300, 1400 of the tower array 100. Tube 105 is arranged so that pressurized liquid may enter the central pipe of each tower and travel to a flow control device at a top of the tower above each of the hub structures. In this manner, each tower has a flow control device at its upper end, such as flow control devices 111, 112, 113, 114, 115 for tower array 100 shown in FIGS. 1 and 2. As shown in FIG. 3A flow control device 111, representative of each of the flow control devices, includes eight output ports with tubes 120-127 attached, so that when those tubes are attached to respective valves on the hub structures 1010, 1020, 1030, 1040, 1050, 1060, 1070, 1080, the flow control device is adapted to distribute any pressurized liquid it receives to up to eight hub structures via the tubes. In variants, any other number of output ports may be included with the flow control devices. In one example the tubes attached to the flow control device are one quarter inch in diameter. Thus, with the position of the flow control devices as shown in FIG. 1, each flow control device reaches eight hub structures on the tower array. Through this arrangement, one flow control device may distribute fluids to up to forty eight plants, i.e., eight hub structures with six plants held in each. Each flow control device includes a pressure control mechanism to regulate pressure of liquid it receives and also includes a flow control mechanism to control the flow rate of the liquid as it is output through the output ports. The flow control device is available with these features and does not require aftermarket modification for use as contemplated herein. It should be appreciated that although downstream tubes from each flow control device are only shown for tower 100 in FIG. 1, such structure is also included in each of towers 200, 300 and 400 in a similar manner and is only emitted from FIG. 1 for clarity.

Although positioned in a particular manner in FIG. 1, the location of each flow control device is a matter of design choice. Thus, in another example, two or more flow control device may be positioned on the central pipe of each tower so that fluid from a single flow control device distributes fluid through more than one tower. Any number of other arrangements are also contemplated. Moreover, although flow control devices are depicted as attached onto or above central pipes, such as shown in FIG. 3A for flow control device 111 on central pipe 1002, such attachment is not a requirement and other arrangements may be utilized as deemed desirable. Further detail regarding the operation of the plant growth system is outlined in the method embodiments.

In some embodiments, the plant growth system may be varied to include liquid input from above the flow control device instead of below it. The structure is otherwise the same as that described for system 2 and shown in FIGS. 1-3A, however, no liquid would pass through the central pipe during operation. Instead, liquid would be received by the flow control device from above, where it would then be distributed via tubes to each hub structure.

In another embodiment, a plant growth system includes a tower 8000, as shown in FIG. 3B. An input tube 805 transports liquid received in flow control device 811 from above. Again, once liquid is received in flow control device 811, it is controlled for a preset flow rate and then distributed to respective hub structures 8010-8080 at the preset flow rate via tubes 820-827. However, an additional distinction in tower 8000 is that a rotary union 831 is attached as an interface between input tube 805 and flow control device 811. Rotary union 831 is attached to flow control device 811 so that tower 8000 is rotatable relative to tube 805 without torqueing or otherwise applying force to tube 805. This functionality is further facilitated by the inclusion of a foundation structure as shown in FIG. 7B. For the foundation shown in FIG. 7B, like reference numerals refer to like elements shown in FIG. 7A. Central pipe 8002 is positioned within sleeve 8004 as described for FIG. 7A, although in addition, a thrust bearing 8009 is positioned at the base of sleeve 8004 so that central pipe 8002 is rotatable 832 about its axis. In this manner, through the thrust bearing, central tube is rotatable, while not causing damage or recurring loads to input tube 805 when such rotation is effected, since a rotary union separates tower 8000 from input tube 805. In other examples, it is contemplated that devices having a similar function to a thrust bearing may also be used.

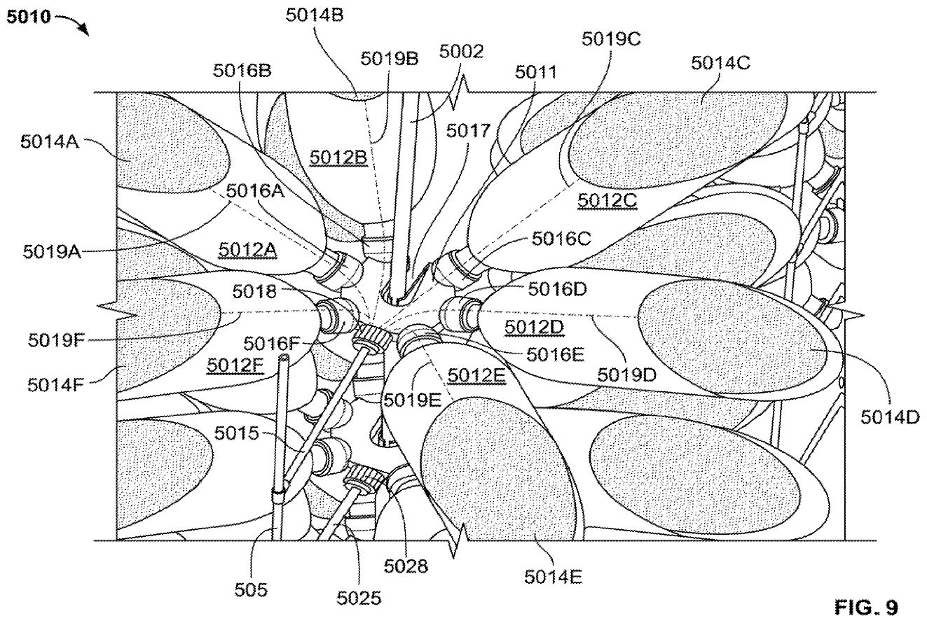

In another embodiment, a plant growth system includes the same structure for one or more tower arrays as described for plant growth system 2, but is configured to bring liquid to plants or crops in the bottles on the hub structures in a different manner. Such plant growth system 12 is illustrated in FIG. 8. The features of this embodiment will now be described in the context of representative hub structure 5010 on tower 5000 of plant growth system 12. Unless otherwise noted, like reference numerals refer to like elements as provided in the embodiment illustrated in FIGS. 1-2 and certain other figures, including 3A, 4-6 and 7A.

In this arrangement, similar to plant growth system 2, plant growth system 12 includes a liquid input 13, a pump 14 in fluid communication with the liquid input, and an output tube 15 adapted to transport pressurized liquid from pump 14. An extension of tube 15 into each tower passes a valve, such as valve 16, so that receipt of liquid in tower 5000, or additional towers in a tower array, is controllable. Downstream of valve 16 is tube 505, extending upward along a length of tower 5000. At each level of tower 5000 is a connection tube that connects tube 505 with a hub structure. Thus, for the tower shown in FIG. 8, there are eight connection tubes 5015, 5025, 5035, 5045, 5055, 5065, 5075, 5085 corresponding to eight hub structures 5010, 5020, 5030, 5040, 5050, 5060, 5070, 5080.

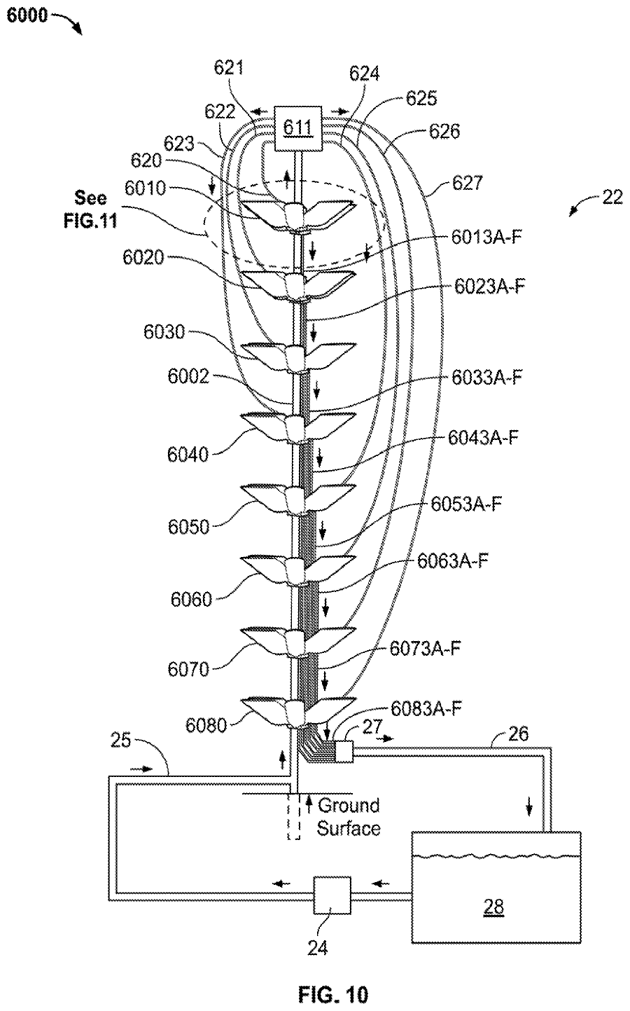

For receipt of liquid in hub structure 5010 specifically, FIG. 9 illustrates that connection tube 5015 receives liquid inflow from tube 505 and transfers such liquid into hub structure 5010. Thus, through this configuration, each level of tower 5000 is connected to the others through tube 505 in combination with the connection tubes. In some examples, if the plant growth system includes additional towers to form a tower array (not shown in FIG. 8), then hub structures of each additional tower, i.e., column, are similarly interconnected through vertical tubes in combination with connection tubes.

Turning to the detailed structure of representative hub structure 5010 illustrated in FIG. 9, hub structure 5010 includes a hub base 5011, bottles 5012A-F and pressure compensating emitter 5018 in direct fluid communication with connection tube 5015.

Hub base 5011 is generally circular in shape and includes an array of engagement features in the form of threaded ports 5016A-F around its circumference, as shown in FIG. 9. A radial slot 5017 extends from a center of hub base 5011 to its edge. Slot 5017 is defined by a U-shape and includes a width sufficient to accommodate disposal of a pipe, rod or rope therein, such as central pipe 5002 shown in FIG. 9. Within slot 5017 or in between threaded necks of threaded ports 5016A-F are connective features (not shown) on surfaces of hub base 5011. Examples of connective features include cleats and fastening holes. The connective features are shaped and positioned so that central pipe 5002 is attachable to hub base 5011. In an alternative arrangement, some of these connective features are also shaped and positioned to permit attachment of a suspended rope (not shown in FIG. 9) to hub base 5011. In other arrangements where the central support structure is a threaded rod, slot 5017 of hub base 5011 may include corresponding threads or a partially threaded locking mechanism as a means of attachment between the two.

On an edge of hub base 5011 is an interface with pressure compensating emitter 5018. Emitter 5018 is configured to receive liquid pumped from pump 14 via tube 15, vertical tube 505, and connection tube 5015, and provides control to the flow rate downstream of emitter 5018. This serves an important function as the flow rate at which the liquid reaches soil placed in the bottles of the hub structure should be within a certain range for optimal performance, e.g., consider transpiration, while the flow rate and pressure of the liquid output from pump 14 must be high enough to push the liquid upwards along the towers and also low enough so that the liquid is retained in the soil and is not supplied in excess. Moreover, it is also useful to have consistent flow rates for liquid entering each hub structure, since uncontrolled water flow would push a large amount of water into the lower hub structures of the plant growth system and little, if any, water into the upper hub structures further from the ground.

As one example, pressure of liquid output from pump 14 may be upwards of 50 psi, and, when the liquid reaches a hub structure, the emitter decreases the flow rate down to a controlled, minimal amount in the range of several drops of liquid per second. In another example, a maximum output rate of liquid from emitter 5018 into hub structure 5010 may be 0.5 gallons per hour. This rate of liquid flow is sufficient to promote the growth of plants and other crops in the soil. Plastic bottles used in the embodiments contemplated herein, e.g., new and post-consumer commercially available plastic bottles, are typically of sufficient size so that soil placed therein can support the growth of grains, fruits, herbs, vegetables and other human-use plants. It should be noted that a hydroponic medium may also be used in place of soil. Such a hydroponic medium is intended for the growth and stability of a plant. Examples include rockwool, a lightweight expanded clay aggregate, coconut fiber, coconut chips, perlite and vermiculite. Additionally, a combination of soil and a hydroponic medium may also be used so that the hydroponic medium prevents soil and substrate from filling the hub structure.

Threaded necks of bottles 5012A-F are screwed onto corresponding threaded ports 5016A-F of hub structure 5010, as shown in FIG. 9. The use of these necks as an interface is advantageous as they conform to an industry standard and therefore are interchangeable with one another. Bottles 5012A-F are cut from the bottom leaving a rim, so that the cut bottle includes an open cavity allowing for the placement of soil or other materials therein. In the depicted embodiment, each bottle is at least partially filled with soil. The bottles may be empty soda bottles such as bottles made of polycarbonate that would otherwise be suitable for recycling. An advantage of using such materials is that they are readily available in areas with limited resources, making the assembly of the described plant growth system a realistic and practical option for growing and irrigating crops. Also, by incorporating used bottles into the system that would otherwise be wasted where recycling is not possible, less energy is spent on disposing of such bottles and less waste and pollution is generated. Further, each soda bottle may be easily replaced on a hub as necessary, allowing for simplified repair and maintenance of plant growth system 12.

Within a body of hub base 5011 are one or more strands of a wicking material, such as nylon wick, e.g., see reference numerals 5019A-F, or other materials capable of capillary action. Other means for producing the desired capillary action include positioning a root or soil substrate in the hub base. The wick extends from pressure compensating emitter 5018 to a location close to the surface of the soil in respective bottles 5012A-F each secured to threaded ports 5016A-F of hub structure 5010. Thus, the number of wick strands extending from the hub into the bottles for the hub structure will typically match the number of bottles secured to the hub structure 5010 or simply loop through the hub as a single line looping into and out of each bottle. For hub structure 5010 shown in FIG. 9, there are six wick strands. The structure and arrangement of the wick, e.g., wick 5019A, is such that when liquid is pumped through emitter 5018, such liquid will contact the wick and then the combination of evaporation caused by plant transpiration and capillary action will cause the liquid to travel from the emitter to an end of the wick located in a relatively dry area of soil. This can be seen, for example, with the path of travel for wick 5019A from emitter 5018 to its end in the soil of bottle 5012A in FIG. 9.

In a manner similar to hub structures of system 2, each hub structure of tower 5000 is adapted to be rotatable and/or vertically adjustable on the central pipe 5002 of the tower, and similar principles apply to any additional towers included in system 12.

In an alternative arrangement of plant growth system 12, the location of valves 6 may be upstream of one or more towers in a tower array (e.g., upstream of one or more of vertical tubes, such as tube 505) instead of at the inlet to each tower array to more precisely control liquid flow.

The above outdoor plant growth systems, including systems 2 and 12, may be varied in many ways. For example, the system may be hung from rope where the rope is secured to a fixed structure external to the system, such as a tree, to provide a load bearing function. To maintain each tower array, such as tower arrays 100, 200, 300, 400, in a suspended position, additional support structures may be included to connect the central support structure of each tower to one another and/or to an additional external fixed support structure. For example, rope may be used to connect together the hub structures of a tower and/or adjacent towers, and/or to connect the hub structures with a fixed location above the towers. To connect the elements, a rope can be suspended from above a tower array down to a tower. The rope may continue down through the hub structures of the tower to pass through and connect to each hub structure. This may be repeated for other towers in the tower array. In one example, the rope may be a nylon utility rope. The load of the hub structures connected to the rope is borne by a fixed structure at an upper end of the rope above the tower array. In the typical environment where the contemplated plant growth systems are used, the structure providing the fixed location may be a tree branch, a second rope tied to and spanning between two trees, horizontally positioned rod(s), or the like. For added stability, a separate rope may be suspended from two or more towers. Alternatively, the ropes holding the towers of the tower array may be interconnected at an intermediate point below the point of suspension at the fixed location so that only a single rope is attached to the fixed location. Such an arrangement may be used to simplify the securement. Still further, the rope, or plurality of ropes, can be used in place of other central support structures such that each hub of a tower is supported in place by only the rope. For example, a rope may replace central pipe 1002 such that hub structures 1010-1080 are attached along the length of the rope and supported from above by a fixed structure from which the rope is hung.

In another example, the plant growth system utilizes a tube separate from central pipe supporting a tower to bring in liquid, which is then distributed to a flow control device above the hub structures for distribution via tubes attached to the flow control device.

Horticultural and agricultural operations performed with the plant growth systems referenced above and others contemplated in this disclosure significantly reduce the land required to grow plants and/or crops. For instance, in one example, when an acre of land is used to grow strawberries in ground soil, up to approximately 29,500 plants can be grown. With the vertically oriented plant growth system, the same land area may be used to grow up to 124,800 strawberry plants, translating to approximately 4.3 times the yield. Viewed another way, the plant growth system produces the same yield with a 75% smaller land area.

The ability to utilize pipes, rods, ropes, or other such structures as a central support structure provides added versatility to the plant growth system such that it can be assembled without the need to procure materials that are not already readily available.

### Outdoor System with Gravity Controlled Drainage

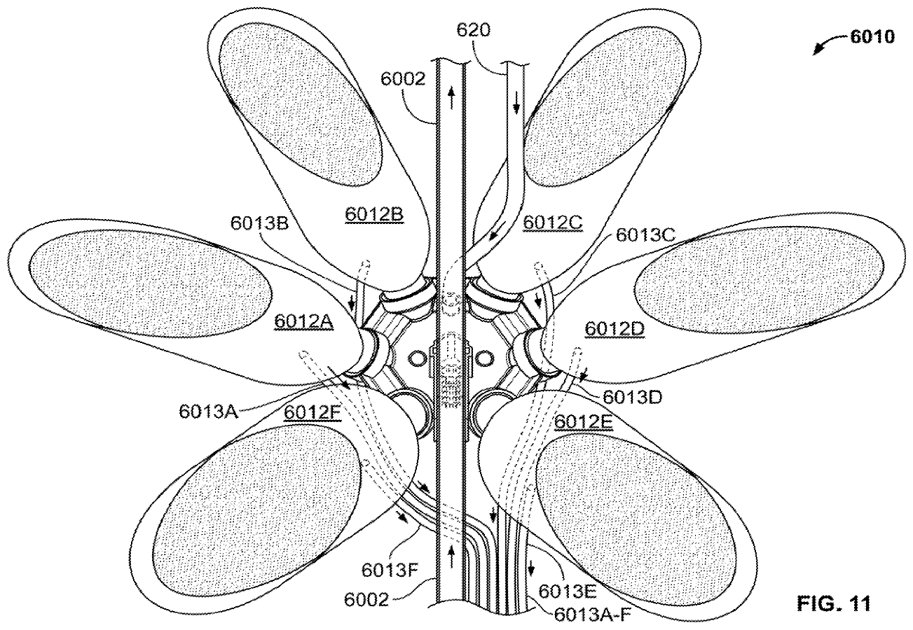

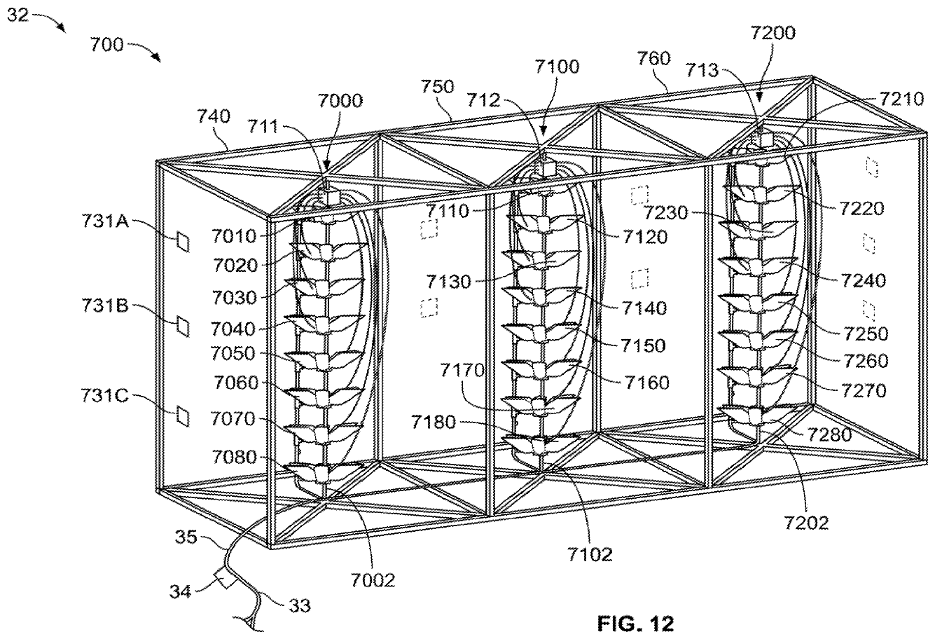

In another embodiment, a plant growth system is provided that irrigates crops through the use of aquaponics and gravity for drainage, as shown in FIGS. 10-11. Unless otherwise indicated, like reference numerals refer to like elements with reference to the embodiment of FIGS. 1-2. Additionally, to the extent components of the plant growth system are not described, such components may be as described for other embodiments herein. System 22 includes a pump 24, a tower 6000, and a fish tank 28. Each component is in fluid communication through a series of tubes, e.g., reference numerals 25 and 26, which form a closed loop for the system.

As shown in FIG. 10, tube 25 is positioned downstream of pump 24. Tube 25 is in fluid communication with central pipe 6002 in a manner so that pressurized liquid is input into central pipe 6002 at a base of tower 6000. As with certain other embodiments described herein, central pipe 6002 is configured to carry pressurized liquid to a flow control device 611 at a top of tower 6000, as shown in FIG. 1, above the uppermost hub structure. Central pipe 6002 operates as a structural support for the tower as well as a path for distribution of liquid to the flow control device. From flow control device 61, distribution tubes 620-627 extend to valves on respective hub structures. Each bottle on the hub structure is adapted to receive liquid entering through the valve. Further, at a base of each bottle is a collection tube that receives any liquid not otherwise absorbed or retained within the soil in the bottle. Thus, for hub structure 6010 shown in FIG. 11, there are six collection tubes 6013A-F adapted to receive liquid from a base of the respective bottles 6012A-F. Each of collection tubes 6013A-F extend from a bottle to valve 27, shown in FIG. 10. A similar flow path is provided for hub structures 6020, 6030, 6040, 6050, 6060, 6070, and 6080. In the same manner, collection tubes for each of these respective hub structures, 6023A-F, 6033A-F, 6043A-F, 6053A-F, 6063A-F, 6073A-F, 6083A-F, all interface with valve 27 downstream of a bottle to which each attaches. In some examples, collection tubes are three eighths of an inch in diameter. One advantage of this configuration is that any backlog in a collection tube does not affect other collection tubes, as they collect separately upstream of valve 27, and, in the upstream direction, such tubes are only in direct fluid communication with the bottle from which they extend. Thus, the risk of overflow in any given bottle is minimized. As with other embodiments of the disclosure, system 22 may include planters or other receptacles attached to the hub structures.

At a downstream end of tower 6000, as illustrated in FIG. 11, collection tubes extending from each bottle of the tower, e.g., forty eight in the tower shown (eight levels of hub structures with six bottles each), interface with an input into a valve 27, which in turn, outputs to return tube 26. FIG. 10 illustrates how plant growth system 22 is a closed loop, where return tube 26 is connected to fish tank 28 at an end opposite valve 27. Thus, the system is configured so that liquid is recycled in a loop, and in this way, fish tank 28 is configured to receive liquid from tube 26 and then further distribute liquid treated in fish tank 28 back to pump 24.

Fish tank 28 is depicted as a tank in FIG. 10, although it may also be an aquarium, pond or other controlled volume supporting aquatic life. A quantity of fish are dispersed in fish tank 28, and are an important component of plant growth system 22. One purpose of fish tank 28 is to process liquid that is distributed through the hub structures of the system so that an output of liquid returning to pump 24 includes ammonia and nitrates. This purpose is fulfilled naturally through the presence of the fish because excrement produced by the fish creates ammonia and nitrates. Thus, as ammonia and nitrates collect in the liquid within the tank, such ammonia and nitrates are subsequently output from the tank with the liquid. This is advantageous for at least two reasons: It limits the exposure of the fish to ammonia, nitrates and other waste compounds, which may be toxic at high levels, and it provides nutrients for the crops and plants of the system.

In some arrangements, valve 27 may be configured to be manually operable to control the release of any liquid within collection tubes or to otherwise allow continuous flow through the plant growth system loop. In others, it may be configured for automatic opening or closing as a function of flows within the system. For example, the valve may be set up to open when flow of liquid through tube 25 is detected, signaling that liquid will flow through or currently flows through collection tubes 25 upstream of valve 27. To provide a desired functionality, valve may also include an electroactuator for additional control. In some examples, an opening and closing of the valve may be programmed to take place at a preset interval. This may be advantageous where plants being grown require water to be flushed after a certain time interval.

In other arrangements of the gravity based plant growth system, liquid received in the collection tubes as drainage may be treated prior to cycling back to the fish tank. One example of treatment includes an evaporative pool for neutralization. If the drainage is acidic, a mechanism to introduce a basic substance may be implemented. If there are salts in the liquid, a product that binds with salt may be incorporated as a treatment, and so on.

In some embodiments, two or more towers may be included as part of the gravity based plant growth system. In these configurations, a tube or tubes downstream of a pump may include one or more valves to control which towers receive liquid input. Thus, for example, in a system with three towers, valves may be positioned upstream of each. These valves may be configured for remote operation via wireless communication. In this manner, the valves may be actuated to allow liquid to flow into any one of the three towers, any combination of two of the three towers, or all three towers. Moreover, this control of the tower receiving liquid also allows unique nutrients to be distributed to a particular tower based on the type of plant being cultivated. Similarly, an amount of liquid supplied may vary from tower to tower and through the control of valves to isolate particular towers, water volumes provided to specific towers may be customized. These principles are described here for the system shown in FIGS. 10 and 11, but it is also contemplated that such customization may be employed in other plant growth systems of the disclosure, such as that shown in FIG. 1.

### Indoor Systems

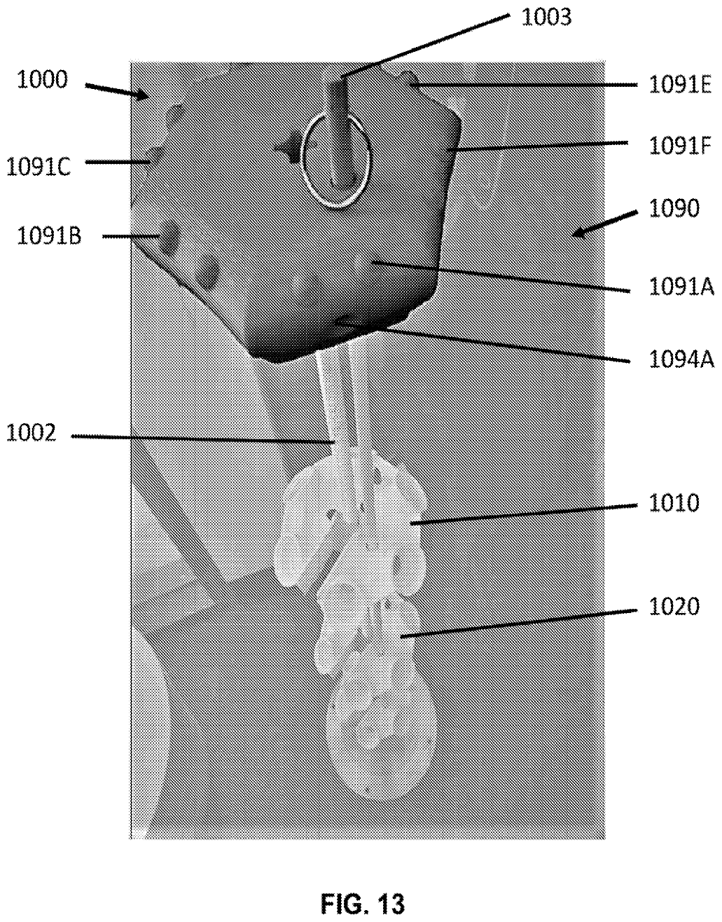

In some embodiments, the plant growth system of any embodiment described herein may be assembled for indoor use and supplemented with light augmentation. In some examples, such indoor use may be within a warehouse or another building type without any exposure to natural light from the sun or at most minimal exposure. In these applications, the system relies on light augmentation to substitute for natural light. One example of a system configuration for such indoor placement is illustrated in FIG. 12. Unless otherwise noted, like reference numerals refer to like elements as shown in FIGS. 1-2.

Plant growth system 32 shown in FIG. 12 includes a tower array 700 and liquid distribution structure with flow control devices 711, 712, 713 and is similar to plant growth system 2. However, instead of having central pipes 7002, 7102, 7202 extend into the ground to define a foundation to support each tower, a series of frame structures 740, 750, 760 are erected to surround each tower and hold each end of central pipes 7002, 7102, 7202 in place. Each frame is bound by at least four columns and employs cross beams at its lower and upper bounds. Of course, the exact position and number of support members may vary and is guided by what would provide a structurally sound frame. The central pipe of each tower is attached to the cross-point at the top and the bottom so that it is centered within the frame. Where two or more frames are included, such as the three shown in FIG. 12, two columns may be shared between adjacent frames. One indoor arrangement places the frame or frames over a concrete floor.

Additionally, frames 740, 750, 760 serve a function of providing enclosures for each tower. This is advantageous because when frames have walls that surround each tower, lighting such as LED units 731A-C, may be positioned on the walls and directed to plants in the hub structures. With each tower enclosed by walls, light emitted from the lighting units can be directed to the plants as desired to obtain optimal growth. One factor in the determination of a position of each LED unit is the leaf area index of the plants within the applicable tower. Thus, for example, LEDs are positioned on the side walls of the frame enclosure so that the light is directed to plants from the sides and reaches a maximum area of leaf surfaces on the plants. A door or doors (not shown) may be included on at least one side of the frame to provide access to the tower and plants therein. In an alternative arrangement, the frame may be absent one or more walls and lighting may be directed into the frame from other locations within the enclosed building. In some examples, the tops and branches of plants can be trained with stakes or otherwise fixed to the central pipe or hub base, thereby orienting the aperture of the branch structures such that the aperture of the leaf area that receives light from the LED(s) or other lights sources is maximized. In this manner, a maximum amount of light originating from the light source is absorbed by the leaf.

In other examples of indoor applications, the plant growth system may be placed in a greenhouse. The features outlined above may be advantageous in such applications where a degree of light augmentation is required within the greenhouse, for the same reasons outlined above. Additionally, for the same reasons that optimization of floor space is important in an enclosed building, similar challenges arise in utilization of space within a greenhouse.

In some arrangements, the central pipes may be attached to a base of a respective frame so that the central pipe is free to rotate about its longitudinal axis. In such a configuration, a source of pressurized liquid is pumped into each tower from a tube positioned above respective flow control devices. In one example, a length of an input tube is positioned from ground level, up a wall of the first frame and then either attached to a ceiling of the frame or above the frame to extend across the frames and pass over each tower. Additionally, similar to the embodiment shown in FIG. 3B, a rotary union is positioned above each of the flow control devices so that the tube is attached to one side of the rotary union and the flow control device attached to the other. With a thrust bearing fixed directly beneath the central pipe of each tower, the central pipe is free to rotate about its axis while the input tube remains stationary. Through controlled rotation of each tower, lighting for individual plants or particular groups of plants on each tower is customizable. Further, an extent and frequency of rotation may be programmed to effectively create rotation cycles for each tower. For example, a tower may be rotated ninety degrees every hour. Thus, a rotational cycle in such example would be four hours, with four quarter turns during that time. Although particularly well suited for indoor applications, it is contemplated that the structure required for rotation of each tower may also be incorporated into outdoor plant growth systems.

In some arrangements, the frames also include casters (not shown), i.e., wheels, mounted on or under the base of the frame or frames. These allow more frames to fit into an enclosed building by providing a way to move one frame relative to another frame to create a walking space in between. Thus, for example, if three of the plant growth systems shown in FIG. 12 are fit into a building, space for as little as one aisle in between the three adjacent frames may be sufficient to house all three systems by moving the systems with respect to each other to access them. In this configuration, all frames may abut one another and an access space may be created between any two as desired by rolling the appropriate frame or frames.

In another embodiment, an indoor system similar to that shown in FIG. 12 may include a series of highly light reflective whiteboards with cut outs for placement of LEDs therein, where the whiteboards are sized to correspond to respective walls of each frame in the indoor system. When set in position within the frame(s), each wall is offset from a wall of the frame by a predetermined amount to create a narrow corridor or channel around the perimeter of each frame, with the frame itself on the outside and the whiteboard on the inside. When positioned in this manner, the channel is sealed off from the interior space housing the plants. The LEDs are positioned in the whiteboard with the lit side facing inward and a heat generating rear portion facing outward. When the LEDs are turned on, a majority of the heat generated is dispersed into the channel area separated from the plants that is exposed to the rear portion of the LEDs. In this manner, the need for temperature control of the plants is greatly reduced, as heat that would otherwise be generated by the LEDs does not have a significant impact on the temperature surrounding the plants. Accordingly, control of the ventilation and gas mixture in the growth area may be made a priority with this configuration.

### Systems with Data Collection

In another aspect, a plant growth system includes a series of data collection devices to complement the base system (e.g., system 2) for producing crops and plants. The inclusion of these data collection devices provides an operator of the plant growth system with network control over conditions in each tower and an ability to monitor such conditions. As described in greater detail below, the network is configured to perform analysis and interpretation in real-time of crop health metrics and reporting of same.

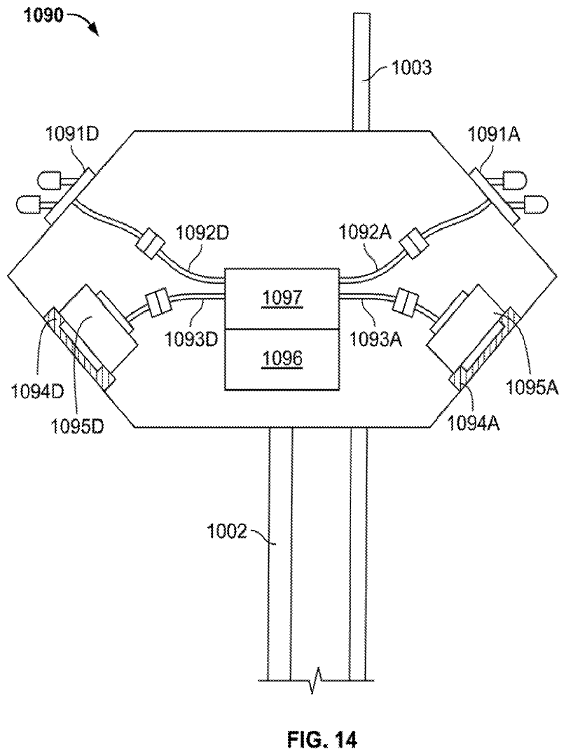

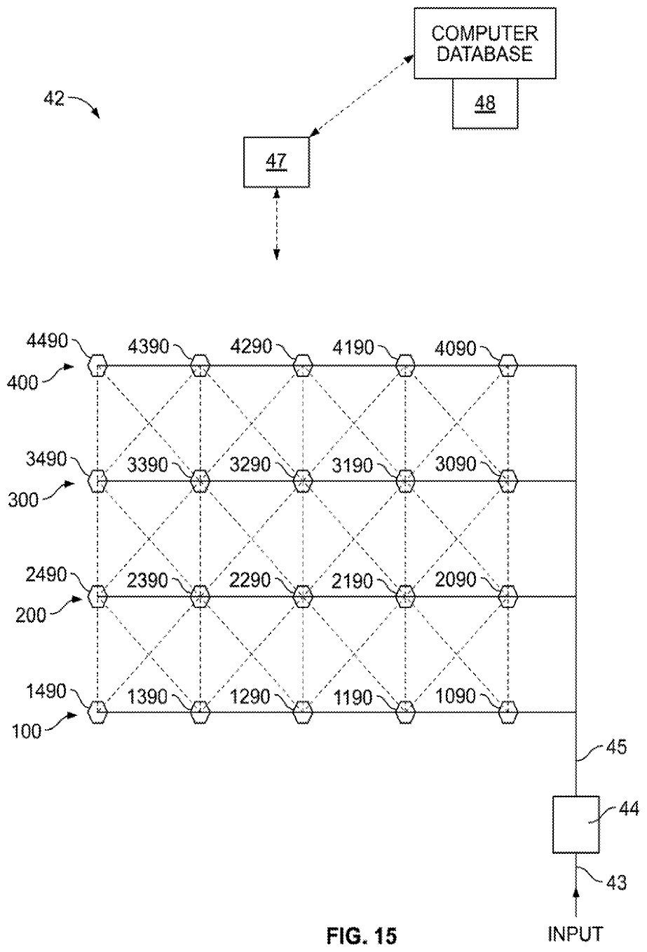

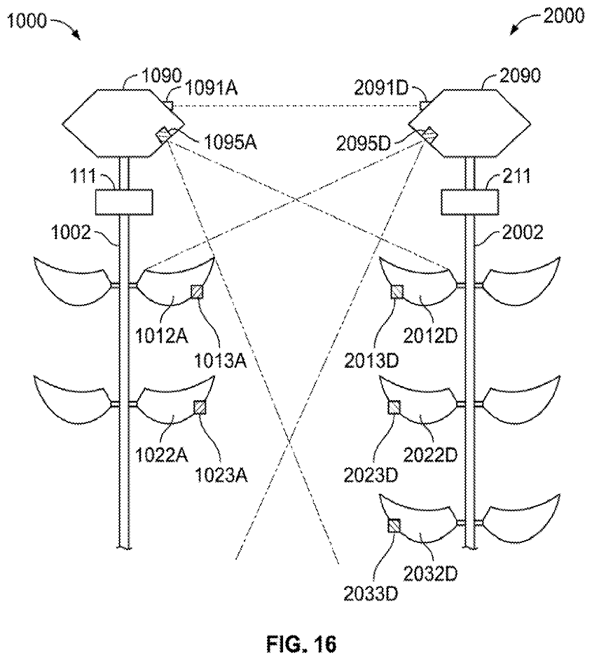

One embodiment of a plant growth system with data collection functionality is illustrated in FIGS. 13-16, where system 42 includes system 2 as shown in FIGS. 1-2 complemented by data collection features attached thereon. One data collection device is positioned above each tower of the system to define a grid of devices, as shown in FIG. 15. In particular, the data collection devices are positioned above the flow control devices in each tower as shown in FIG. 16, for example. When the central pipe is rotatable, a rotary union is positioned below the data collection device directly above the flow control device. In this manner, the central pipe is rotatable while the data collection device remains stationary. Liquid input into the central pipe of the tower may pass through a central opening in the data collection device in this arrangement. Additionally, each data collection device is positioned at the same predetermined distance above the top hub structure on the tower, as seen in FIG. 16. As will be described in greater detail below, having each data collection device at the same height above the ground optimizes communication between the devices via attached sensors and also ensures that any images taken from a data collection device capture all intended crops or plants.

Turning to the details for each data collection device, one representative data collection device is illustrated in FIG. 13. It should be appreciated that other data collection devices, such as those shown in FIG. 15, include the same or similar features. As shown, a single data collection device 1090, is placed near a top end of central pipe 1002 on tower 1000. For additional support and alignment, a dowel 1003 is positioned through the data collection device offset from central pipe 1002. Dowel 1003 is connected to the hub structures and other supporting elements below, and functions to maintain an alignment between the data collection device and the hub structures on the same tower. In this manner, an orientation of the hub structures on a tower are known based on an orientation of the data collection device, and there is no expectation that the data collection device will rotate.

Data collection device 1090 has an outer surface defined by a six sided polygon. Of course, the number of sides and shape may vary if an array of the system is defined by a different pattern. On each side of the device are an infrared sensor 1091A-F and a portal 1094A-F so that a camera inside the structure has no obstructions to spaces outside of the device. The infrared sensors are on an upper portion of a side and are attached to face another data collection device, as shown in FIGS. 15 and 16. This could be one of data collection device 2090, 2190 or 1190, for example. Immediately inside each portal 1094A-F is a camera 1095A-F pointed out of the portal, as shown in FIG. 14. The camera points downward at an approximately forty five degree angle.

Each sensor 1091A-F includes an LED emitter and a photodiode receiver. This allows data regarding the details of the data collection device to be communicated to other data collection devices in the plant growth system. In particular, when the LED emitter emits infrared light, it is received by a photodiode receiver on another data collection device. Specific structures for the LED sensor may vary provided the structures used are capable of emitting and receiving infrared light. The LED sensor is configured to communicate data to a central computer via a connection to a Bluetooth® unit 1097 within the device. For example, with connection 1092A for LED sensor 1091A shown in FIG. 14. Communicated data includes a location of the data collection device relative to other data collection devices in the system. Of course, other information about the data collection device may also be communicated. This functionality may also be incorporated into a self-configuration protocol for the totality of the data collection devices of the system. More on how this data is communicated and used is described in the methods of use for the system.

Further, each data collection device should be oriented in the same manner. This is best accomplished through positioning the dowel relative to the central pipe in the same manner for each data collection device. Thus, a dowel may be positioned directly north of a central pipe for a reference data collection device, and each of the other data collection devices should be positioned in the same manner. It should be appreciated that a single data collection device will operate as a reference point for the system overall in order to effectively identify a location of each data collection device. The reference data collection device, such as device 1090, may be configured, for example, to be calibrated to have coordinates of x=0 and y=0 so that the other data collection devices are identifiable by locations relative to the reference location. Alternatively, device 1090 may be located with GPS and then the other data collection devices may be located relative to it. The infrared sensors are adapted, once each data collection device is confirmed to be aligned in the proper manner, to communicate with other data collection devices of the system to establish a location of each tower in the system. Further detail in this respect is outlined in the method.

Each camera 1095A-F includes a lens sized to capture images, such as photos, of at least a series of eight bottles positioned in a vertical line on a tower that the camera lens faces. This is shown in FIG. 16, for example. Data in an image may be associated with a particular plant based on a location within an image and/or through a unique identification number (UID) tag included on each bottle captured in the image, such as a QR code. Further, images taken by the camera may be stamped with a direction associated with the image, e.g., N, NE, E, SE, S, SW, W, NW, and an identification of the specific data collection device housing the camera. Ultimately, these images allow for retrieval of various data on specific plants along with information to identify a location of particular plants within the plant growth system. The camera is adapted to be programmed for image capture at a regular interval, or may be customized to take images at a changing interval or manually. Details of the method of using the data collection devices and the advantages of such methods are described elsewhere in the application. A DVI or other similar connection 1093A between camera 1095A and Bluetooth unit 1097 or other wireless communication unit inside the data collection device is adapted to transfer its own data and relay the data of other collection devices from cameras so that it can be communicated to and processed at an external central computer. Power to the infrared sensors 1091A-F, the cameras 1094A-F, and the Bluetooth unit are provided through a battery 1096 or other compact power supply unit which may include a small solar panel to source power on-site.

The plant growth system also includes a Bluetooth master unit 47 or multiple master units that are configured to wirelessly receive data collected from each tower of the plant growth system. Additionally, a computer 48 is included that is in communication with Bluetooth master unit 47 to process and store data from the towers of the system. More detail regarding analysis and interpretation of data received by the computer is provided in the description of the method.

In another embodiment, a system with multiple towers is monitored with a single data collection device mounted on a drone. In this configuration, the drone functions to go to any level of a particular tower so that it is possible to capture images of each plant or crop in the system.

### Other Embodiments for Plant Growth System

The plant growth system may be varied in many ways. In some embodiments, control of the pump, valves, flow control device, pressure compensating emitter, data collection device and other operational functions may be provided through software applications linked to the plant growth system. For example, a mobile phone application may be configured to provide an interface with a series of options allowing for control of various features of the system through a cellular network, directly through Wi-Fi or Bluetooth, or other means of serial or radio connection.

In some embodiments, the plant growth system may include additional sensors to improve the efficiency and the monitoring functions of the system. In some examples, these may include one or more of water flow sensors, water quality sensors and soil moisture sensors. Other sensors include a humidity sensor that measures the humidity and temperature of the soil in each bottle. This data may be valuable to determine the transpiration rate of plants to determine whether any change should be made to the flow rate of the liquid input. The above sensors may be placed at various locations within tower arrays of the system and in any quantity. However, only a small quantity of sensors may be necessary to obtain the benefits from their operation. Thus, a water quality sensor may be positioned just downstream of the pump. A single soil moisture sensor and/or single humidity sensor may be sufficient to monitor a single tower.

In other embodiments, the hub structures on a tower include bottles that are snapped into place onto ports on the hub base, i.e., “click-on” bottles. In this manner, the bottles may be removed and replaced with ease. Such replacement allows for the use of bottles having different sizes and shapes. Also, to the extent that the plants or the soil need to be accessed for treatment or other adjustments, removal of the bottle on a temporary basis renders this process simpler and more effective. It is contemplated that the click-on feature for the bottles may be incorporated into any embodiment of the plant growth system described herein. Further, as with other embodiments of the system described herein, bottles may be substituted with other receptacles such as planters.

In other embodiments, two or more towers within a tower array may be of differing heights or have different quantities of hub structures. Although depicted as being positioned in parallel rows, any orientation of one tower array relative to another tower array is also contemplated. For example, the rows of a first tower array may be transverse to the rows of an adjacent tower array. Consistent with these additional embodiments, it is contemplated that the plant growth system may include any number of tower arrays and any number of hub structures, rows and or towers, i.e., columns, on any one tower array of a system. In at least this manner, the system is in no way limited by the depicted embodiments. Similarly, the exact position and connection mechanisms between a central support structure and a hub structure or tubes and the hub structure may vary from those shown in FIG. 4 or FIG. 9 to suit the materials available under a given set of circumstances. In other embodiments, the system may include only one of vertical central pipe, rod or ropes holding the frames in suspension. As noted elsewhere in this disclosure, in any one of the contemplated embodiments, the system may be employed in an outdoor environment so that the crops and plants are exposed to natural lighting or the system may be set up and operated in an indoor setting with artificial light sources used in place of natural lighting.

One advantage of many of the plant growth systems described herein is that, if needed, each component of the system may be sourced even where the availability of construction materials is otherwise very limited, such as in developing countries. For example, galvanized steel pipe, PVC pipe, plastic bottles, other plastic components, metal rods, rope, nylon rope (for wicks) and simple mechanical devices such as pumps and valves may be regionally sourced even in poorly developed areas. Thus, the system can produce valuable output with rudimentary input materials and in this way the starting materials are not a barrier to implementing the system.

In still further embodiments, the system may be accompanied by a screen to cover all of the crops to reduce or remove the need for treatment with herbicides or pesticides. Because the systems are vertically oriented, a screen is a pragmatic option with the system due to relatively small area required for production, whereas it would often not be with soil-based plants or crops.

### Kits

In another aspect, the components of the above plant growth system may be included together as a kit. In one embodiment, a kit is a collection of one or more of any combination of tubes, pipes, rods, rope, hub bases, bottles, flow control devices, pressure compensating emitters, valves, pumps and data collection devices. These elements may be packaged in a crate or a series of crates, or another form of containment structure. In examples of this kit, any number of each of the above elements may be included as part of the kit. In another embodiment, a kit includes only some elements of the system. For example, a kit may include several dozen bottles and hub bases. It is contemplated that any combination of the elements used to form the system may be combined to form a kit.

In some arrangements, the kit may also include a computer application which can be used on a cellular phone to connect the phone to the plant growth system, for example, plant growth system 2. Thus, in addition to manual control of the system, a computer system and program may be used. Via the phone and computer application, system 2 can be turned on and off, certain towers can be irrigated or not (via the valve(s), for example solenoid valves), the timing of an irrigation cycle can be adjusted, and the like. Any and all functions of the system capable of being automated may also be scheduled on such a system. Furthermore, feedback from sensors located on the system may send information back to the application regarding the current or previous state of the system. Such a sensor might register soil moisture, water ph, pump activity etc. among other conditions within the system.

### Method of Irrigation with Pressurized Liquid System

In yet another aspect, the present disclosure relates to a method of irrigating plants and/or crops using the plant growth system of the various embodiments contemplated herein.

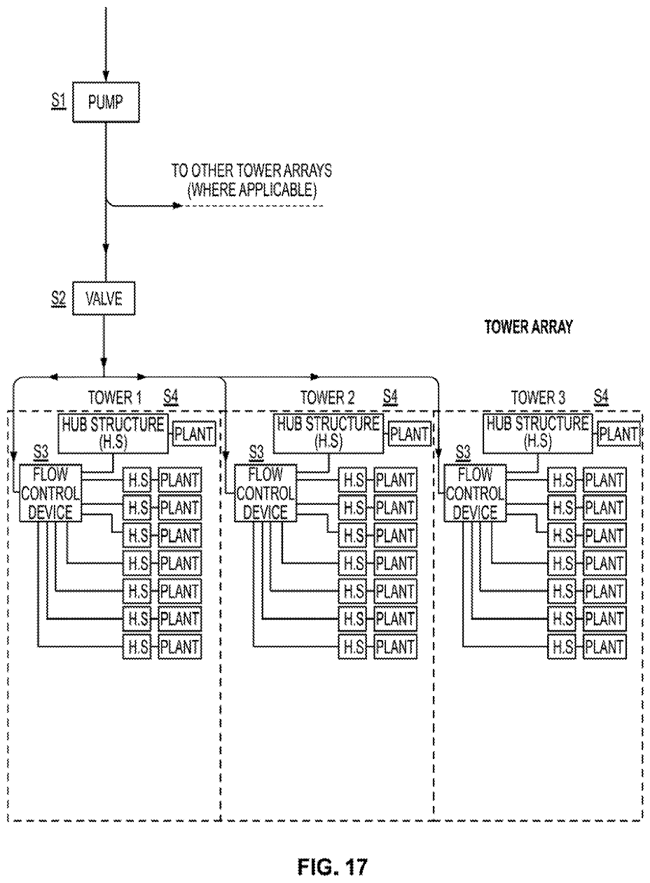

In one embodiment, depicted through the steps of the flow chart shown in FIG. 17, the elements for which are also shown in FIG. 1, a liquid from an outside source is first received at a pump in step S1. When liquid is pumped into the system, it may be supplied with fertilizer and/or other nutrients for various purposes. For example, when leaf growth is required in the plants, nutrients are provided to supply increased nitrogen. With the pump turned on, the liquid is pumped into a downstream tube toward one or more towers of the plant growth system, each having a plurality of hub structures. At step S2, the liquid reaches a control valve for the first tower array which may be open or closed. Where two or more tower arrays are included, it may be desirable in some instances to close the valve so that liquid only flows to the second tower array or other tower arrays. In an alternative method, each tower array may include a series of valves to control how many towers within a tower array receive liquid. Provided it remains open, liquid continues toward one or more flow control devices installed to distribute liquid throughout the tower array.

At step S3, the liquid is received in the one or more flow control devices, where it passes through a pressure compensating emitter prior to exiting from one of eight output tubes. In this manner, the flow control device may receive liquid at a wide range of pressures, such as anywhere between 10 and 90 psi or for some configurations, other ranges in between these amounts, and output such liquid at a controlled flow rate to each of the eight output tubes. For purposes of the plant growth systems described herein, the flow rate of liquid output from each flow control device is typically 0.25 gallons per hour, though flow control devices configured for other flow rates are also contemplated, such as 0.50 gallons per hour, for example. Further, a flow rate for some plants may be greater than others, even within the same system. This may be accomplished through the use of different types of flow control devices throughout the system. Through control of the flow rate, liquid may be received in each bottle at a desired rate appropriate for irrigation, even with a wide range of liquid pressure upstream. This makes the system more adaptable to changing conditions so that predictable crop growth may be expected.

At step S4, liquid is output from each of the eight tubes that extend from the flow control device and flows to an inlet on a hub structure, where it is then distributed to the plants and/or crops on such hub structure. It should be appreciated that the flow rate may be determined based on a transpiration rate of the plants and/or crops within the system. Thus, by choosing the appropriate flow rate based on the plants grown, it should be expected that there is minimal or no residual liquid following irrigation of each plant, maximizing water use and minimizing waste, while also eliminating the need for a separate drainage system. Water is received in the soil of respective bottles, and plants and other crops therein are irrigated to promote growth. Thus, for each flow control device, eight hub structures, including all plants thereon, are supplied with liquid from one of the eight tubes output from the flow control device. In this manner, if a tower array with three towers includes eight rows of hub structures for each tower and each hub structure has six bottles with plants therein, then there are twenty four hub structures and 144 bottles with plants. Because a flow control device can supply up to eight hub structures with liquid for irrigation, such a plant growth system is supplied with adequate water through the inclusion of three flow control devices. In an alternative approach, certain flow control devices of the system may be switched off via a program or manually to selectively treat a subset of plants within the plant growth system.

In another embodiment of the method, nutrients can be mixed into the soil in a strategic manner. In yet another embodiment, nutrients may be introduced into the liquid supply in a slow release. In yet another embodiment, the liquid flow in the method passes through a tube inside the hub base that extends from the valve, enters the bottle and extends to the top of the soil in the bottle. In this manner, liquid enters the soil from a top surface of the soil, passes through nutrients, and then continues through the soil and the roots of the plants or crops. Through performance of the method in this configuration, the roots of the plant are washed, which is advantageous when the roots accumulate too much nutrient, salt or other plant wastes.

In another embodiment of the method, step S3 is replaced with a process where liquid flows under pressure up a tube in each tower, and from such tube, to each hub structure on the tower. The liquid reaches individual pressure compensating emitters at an input location of a hub structure at each level of the tower. The pressure compensating emitter controls the flow of liquid output into the adjustable hub to a maximum flow rate of approximately 0.5 gallons per hour. Through capillary action, the liquid then flows along one or more wicks, each extending into soil within bottles attached to the adjustable hub. In step S4, water is received in the soil of respective bottles, and plants and other crops therein are irrigated to promote growth. A similar process occurs for each tower in the tower array downstream from the valve opened at step S2.

### Method of Irrigation with Gravity Controlled Drainage

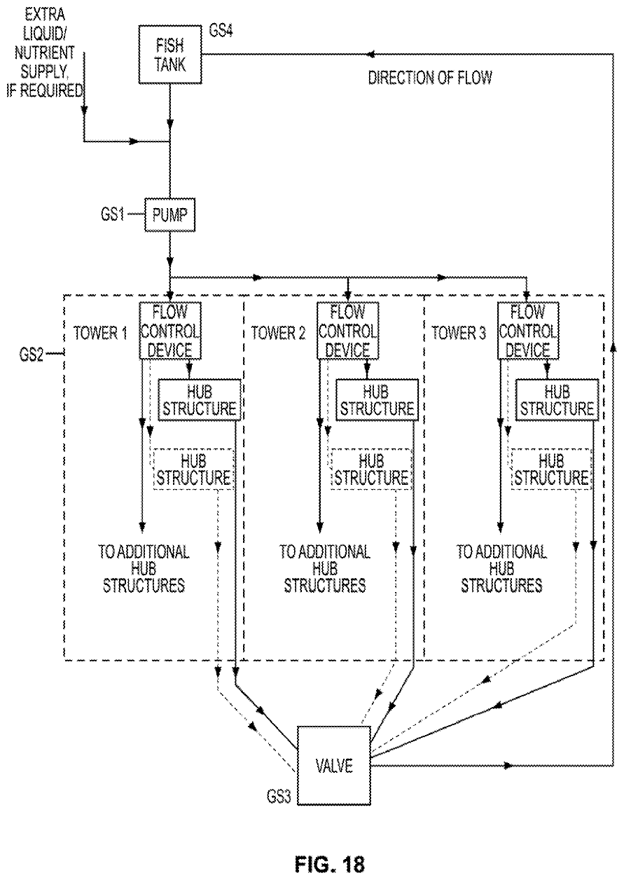

In another embodiment, the plant growth system of FIG. 18 is employed in a method of irrigating plants and/or crops. At step GS1, liquid containing ammonia, nitrates, growth promoting microbiota and micronutrients are pumped from a pump into a tube connected to a central tube of a tower. Once into the central tube, the liquid flows upward into the flow control device located at a position above the hub structures of the tower. At step GS2, liquid within the flow control device is regulated to a controlled flow rate and then distributed to respective hub structures, as shown in FIG. 10, and from there, to the soil or hydroponic growing medium of individual plant-supporting bottles. Upon reaching the plants, the ammonia in the water converts to nitrate which the plants use as food. As shown in FIGS. 10 and 11, from within each bottle, any liquid not absorbed in the soil of respective bottles flows independently via gravity through a collection tube to a valve at a base of the tower.

At step GS3, each collection tube representing excess liquid from each bottle that has undergone irrigation, e.g., 6013A-F in FIG. 11, collects upstream of the valve structure. While the pump is on, the valve is controlled to be in an open position to ensure there is no backlog of liquid in the collection tubes. Through the open valve, the used liquid returns to the fish tank. At step GS4, liquid received in the fish tank accumulates ammonia and nitrates through the collection of fish excrement in the tank. Such ammonia and nitrates-containing liquid is then output to the pump. This marks the completion of the cycle and the process is repeated.

### Method of System Operation with Sensors

In another aspect, plant growth system 42 may be operated in conjunction with data collection functionality through the incorporation of data collection devices as shown in FIGS. 13-16. Prior to calibrating the data collection devices located above each tower, as shown in FIG. 15, a brief assessment of each device is made to ensure correct orientation above a tower, its correct position at the proper elevation in the system, and that it is secured in place. For system 42, this is done for data collection devices 1090-1490, 2090-2490, 3090-3490, 4090-4490. To verify that each device is oriented correctly, the dowel positioned offset to the central pipe through the device may be viewed. In one approach, a line from the central pipe through the dowel may be oriented to point directly north. In any event, once a line is established based on a distance between the central pipe and the dowel, the other data collection devices may be oriented in the same manner. Verification of a height of each device ensures that all are at the same elevation. This minimizes the risk that any communication between sensors on each device is inadequate or ineffective.

To verify a location of each plant, the data collection devices are calibrated. This may also be referred to as a self-configuration protocol. Calibration begins with a reference data collection device identified as located at x=0 and y=0 coordinates. Alternatively, the reference data collection device may be identified by GPS coordinates. For the plant growth system of FIG. 15, device 1090 is the reference device. Once each device is turned on, infrared sensors, e.g., sensors 1091A-F on device 1090, activate and emit infrared light via an infrared pulse. This sends identification and location data of the source device to the receiving device. Due to the unique six sided structure of each data collection device, each device will be in communication with at least one other device via this infrared transmission, as the infrared light is received on a photodiode receiver of a receiving device. For example, in FIG. 15, device 1090 is in communication with devices 2090 and 2190 via its infrared sensors. In another example, device 3290 is in communication with devices 2190, 2290, 2390, 4190, 4290, 4390. The efficiency of this communication between devices is enhanced due to the patterned geometry of the system, as best shown in FIG. 15. Once each device is in communication with the others, the devices calculate their position relative to the reference device 1090. This data is then saved and relayed to computer 48, along with any other data collected at that particular device, as will be described below. Thus, through the above process, each of the data collection devices such as those shown in FIG. 15 may be located through communication based on the infrared sensors. One purpose of having the location of each device, and thereby the location of each tower, is to aid in monitoring the development of individual or groups of crops or plants in the system.

To collect data on each plant over a period of time, each data collection device is programmed to take images with a built in camera at a predetermined time interval, such as with cameras 1095A, 1095D shown in FIG. 14. Of course, commands to take images may set varying time intervals, may be manually set, or may vary from tower to tower within the plant growth system. In one example, each data collection device is programmed to take images at thirty minute intervals. Data obtained through these images is then analyzed to monitor progress and growth of plants and/or crops throughout the system. To set up a program for each data collection device to capture images, input is entered into a computer 48 and communicated to plant growth system 42. Communication between computer 48 and the data collection devices of system 42 is wireless. In the system described, Bluetooth is used to facilitate wireless communication. It is also contemplated that wireless Bluetooth technology may function to measure the proximity of people to the system, and in this manner, operates as a beacon. Use of other low-energy wireless communication systems is also contemplated. In other variations, wired communication may be implemented.

To acquire data from images taken, and to associate such images with a particular plant in the plant growth system, data collection device 1090 is described and is representative of each data collection device in the system. When it is time for device 1090 to gather data based on the programmed data collection interval, camera 1095A captures an image. As shown in FIG. 16, an image from camera 1095A will capture all plants and/or crops grown on one side of tower 2000. This includes plants within bottles 2012D, 2022D, 2032D, 2042D, 2052D, 2062D, 2072D and 2082D. Additionally, each bottle includes a UID tag 2013D-2083D which is also captured in the same image. When the image data is created through the capture of an image, it is also stamped with an identification of the data collection device housing the camera and a direction in which the camera captured the image, e.g., NE, E, SE, etc. Information on the identification of the data collection device may be separately gathered prior to this step through calibration of the system using the LED sensors. Additionally, the location and general information about the plant may be determined through capture of the UID information in the image along with image data from the image file itself which also includes data relating to a location of the tower that carries the plant in question. Thus, when the image data is communicated via Bluetooth unit 1097 to computer 48 and it is analyzed, the computer is able to utilize a variety of information to associate particular images with locations and particular plants in the system.

Under the above arrangement where the system is programmed to take images at a set time interval, the process also occurs at the same time in each of the other data collection devices and for the plurality of cameras in each. This includes other cameras in the same device 1095B-F, or cameras in other data collection devices (not shown). In this manner, data regarding each plant in the entire system may be gathered through images taken at a single point in time.

Turning to the plant and soil information that may be ascertained from the analysis of the image data by the computer, the image data may be used to evaluate or track information about the soil in a bottle or a plant itself, such as moisture in the soil, the development of the plant (e.g., whether the plant should be harvested), the health of the plant, and may also be used to predict future changes in the plant. In this manner, the data operates as an early warning system for any potential issues with the crops, such as drought, diseases and pests, prior to any adverse impact on expected yield. Image data may also be used to detect treatment activity associated with a plant. For example, the data could show that a spray was used on a particular plant. Optimal harvest dates for individual plants may also be extracted from the analyzed data, along with production tracking, strengthening of genetic breeding programs, among other useful information. The computer in receipt of data from the devices incorporates statistical and predictive algorithms to aid in this process. For some of the analyzed data, blockchain technology may be utilized to streamline collected data to identify any discrepancy with data collected outside of system 42.

Under a program to take images at a regular interval, additional data is fed into the computer on an ongoing basis, building a larger collection of data regarding the plants of the plant growth system. As additional data is collected over time, more complex analyses and trends may be performed to improve an assessment of the plants and to improve decision making regarding changes to the growth operation. For example, after one day of taking images, changes in the characteristics of a single plant may evidence a problem, thereby indicating that attention to that plant is necessary.

During the operational life of the system, the programming for the plant growth system may be altered as desired to capture images at more or less frequent intervals, or to otherwise customize the operational regimen. In further examples, a time interval for image capture may be fifteen minutes, forty five minutes, or an hour. And, these frequencies may be customized for different parts of the system, such as those producing different crops. In other examples, the interval between image capture may be customized by tower or even by camera.

In other embodiments, one or more cameras within the data collection devices may be adapted to take video footage and are programmed to do so as part of a method of monitoring the plant growth system.

In yet another embodiment, a method of growing plants utilizes a plant growth system without any built in data collection devices, but includes a separate data collection device mounted on a drone. In one example, where the system includes a series of tower arrays aligned in a grid pattern, such as system 2 shown in FIG. 1, the drone operates by positioning itself at a center between four towers and moves vertically up and down in such center to capture images of any number of plants facing inward. This process is repeated in each space between towers and also on an outside perimeter until all plants in the system are covered. This method may be implemented in both indoor and outdoor environments.

### Variants of Method

The above method may be varied in many ways. For example, the method may be employed in plant growth systems having two or more tower arrays. In other variants, the control valve controlling liquid entering a tower array may be left out so that any water pumped into a tube connected to towers downstream of the valve will enter the tubes in those towers. In other variants, adjustments to individual hub structures may be made prior to, during or after irrigation. For example, using central pipe 1002, hub structures 1010-1080 (see FIG. 1) may be rotated relative to the hub structures of other towers in the tower array, e.g., tower 1100, to improve overall exposure of plants and crops to sunlight. Similarly, a vertical position of one or more hub structures may be adjusted for similar reasons. Of course, adjustment may be made for other purposes as well, such as avoiding the intrusion of nearby natural obstructions.

Through incorporation of easily accessible materials as described above, the methods of irrigating crops using the plant growth system can be employed without the need for bringing heavy equipment to the placement site. Further, through the use of non-hazardous materials for implementing the method, the system avoids the need to introduce any potentially hazardous chemicals to the site. The method is also advantageous in that very few people are needed for its implementation. For example, it is possible that in at least some circumstances a single individual may assemble and operate the entire plant growth system.

Generally, the plant growth systems described herein are called hydroponic systems. In some embodiments, the systems are a combination of aquaculture and hydroponics commonly known as aquaponics.

Although the disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

1. A vertically oriented plant growth system comprising:
a tower adapted for mounting over a ground surface and comprising:
a central support structure oriented generally perpendicular to the ground surface, the central support structure supported by either an above ground frame or an extension through the ground surface functioning as a foundation;
a plurality of hub structures attached to the central support structure and spaced at intervals along the central support structure, each hub structure including at least one container attached thereto sized for the disposal of soil sufficient to grow a plant;
a flow control device with output tubes extending to an input valve on each of the plurality of hub structures;
an enclosed channel in fluid communication with a source of liquid under pressure and the flow control device,
wherein when the liquid is distributed downstream from the source through the enclosed channel and then into and through the flow control device, the liquid dispenses into soil disposed in each container at a predetermined flow rate.

2. The system of claim 1, wherein the flow control device is mounted above the plurality of hub structures.

3. The system of claim 1, wherein the enclosed channel is directly connected to the central support structure such that pressurized liquid received in the enclosed channel travels downstream through the central support structure and into the flow control device.

4. The system of claim 1, wherein the enclosed channel is directly connected to the flow control device.

5. The system of claim 4, wherein the central support structure is rotatable about its axis and rotation of the central support structure does not transfer forces to the enclosed channel.

6. The system of claim 5, further comprising a rotary union attached to the flow control device opposite the central support structure such that the flow control device separates the rotary union and the central support structure, the flow control device and the central support structure adapted to rotate in unison.

7. The system of claim 1, further comprising a second tower adapted for mounting over a ground surface that includes:
a second central support structure oriented generally perpendicular to the ground surface, the second central support structure supported by either an above ground frame or an extension through the ground surface functioning as a foundation;
a second plurality of hub structures attached to the second central support structure and spaced at intervals along the second central support structure, each hub structure including at least one container attached thereto sized for the disposal of soil sufficient to grow a plant.

8. The system of claim 7, further comprising a valve located on the enclosed channel upstream of each of the two towers, the valves being independently actuatable to control flow of pressurized liquid into either one or both of the two towers.

9. The system of claim 7, further comprising a second flow control device positioned above each hub structure of one of the two towers while the first flow control device is positioned above each hub structure of the other of the two towers.

10. The system of claim 9, wherein the first flow control device is configured to regulate liquid output to a first flow rate and the second flow control device is configured to regulate liquid output to a second flow rate.

11. The system of claim 9, wherein each tower further comprises a data collection device positioned on the central pipe above respective flow control devices, the data collection device adapted to collect data associated with conditions of the soil and plant disposed in each container on an adjacent tower.

12. The system of claim 11, wherein the data collection devices further comprise infrared sensors such that each data collection device is adapted to communicate with the other to establish a position of each.

13. The system of claim 11, wherein the data collection devices further comprise a camera adapted to capture image data of each container on an adjacent tower.

14. A system comprising:
a first tower array including three towers;
a second tower array including three towers;
wherein each of the towers in each tower array includes:
a central support structure;
a plurality of hub structures each centered on the central support structure and spaced apart from one another;
a flow control device positioned above the plurality of hub structures, the flow control device including eight outputs each with distribution tubes attached thereto;
wherein each of the plurality of hub structures includes an input valve connected to one of the eight distribution tubes, and
wherein the flow control device is configured to receive liquid and distribute the liquid to each planter attached to the hub structure on the tower,
wherein the three towers of the first tower array are aligned with one another such that a first axis passes through the central support structure of each;
wherein the three towers of the second tower array are aligned with one another such that a second axis passes through the central support structure of each, the second axis parallel to the first axis;
wherein a third axis perpendicular to the first axis and passing through one of the three towers of the first tower array also passes through one of the three towers of the second tower array.

15. The system of claim 14, wherein each tower further comprises a data collection device positioned on the central pipe above the flow control device, each data collection device being positioned at the same elevation so that infrared sensors on any one data collection device are in communication with infrared sensors on another data collection device.

16. The system of claim 15, wherein the data collection device is adapted to run a self calibration protocol so that a location of each tower relative to a reference tower is established.

17. The system of claim 14, wherein each data collection device further comprises six cameras, each camera positioned facing a different direction such that image data on the planters positioned on each tower is retrievable, the image data being associated with conditions of the soil and plant in each container.

18. The system of claim 17, wherein the image data is associated with a direction the camera faces and the tower housing the camera.

19. A vertically oriented plant growth system comprising:
a first tower array including two towers; and
a second tower array including two towers, a single axis through the two towers of the second tower array being parallel to a single axis through the two towers of the first tower array,
wherein each tower of the first and second tower arrays comprises:
a central support structure extending upward from a ground surface;
a plurality of hub structures with one or more planters attached, each hub structure attached to the central support structure and spaced from an adjacent central support structure; and
a data collection device positioned above the plurality of hub structures at a predetermined distance from the ground surface,
wherein the data collection devices are operable to collect location data regarding each tower through communication between sensors on each data collection device, and
wherein the data collection devices are operable to collect data regarding contents of the planters on each tower through image data collected from images captured by an electronic device within the data collection devices.

20. A vertically oriented plant growth system comprising:
a tower comprising:
a central support structure;
a plurality of hub structures each centered on the central support structure and spaced apart from one another, each of the plurality of hub structures include a plurality of planters attached thereto, at least one of the planters having soil or a hydroponic growth medium disposed therein;
a flow control device positioned above the plurality of hub structures and connected to the central support structure, the flow control device including a plurality of outputs each with distribution tubes attached thereto;
a plurality of distribution tubes, each distribution tube connected to one of the plurality of outputs of the flow control device at one end and a valve of one of the plurality of hub structures at an opposite end; and
a plurality of collection tubes, each collection tube connected to an opening in one of the planters at one end and a central valve at an opposite end,
a body for filtering liquid, the body adapted to receive liquid downstream of the central valve,
a pump, the pump adapted to receive liquid treated by the body and to distribute pressurized liquid to the central support structure; and
wherein when pressurized liquid flows downstream from the pump, liquid is pumped through the central support structure into the flow control device and then distributed separately into individual hub structures and the planters attached thereto such that any liquid not absorbed by soil in the planters flows downstream by gravity into collection tubes and returns to the body when the central valve is open.

21. A method of irrigating plants comprising:
providing pressurized liquid to a tower comprising:
a central support structure;
a plurality of hub structures each centered on the central support structure and spaced apart from one another, each of the plurality of hub structures including a plurality of planters attached thereto, at least one of the planters having soil or a hydroponic growth medium disposed therein; and
a flow control device positioned above the plurality of hub structures and connected to the central support structure, the flow control device including a plurality of outputs each with distribution tubes attached thereto;
wherein the liquid travels through the central support structure to the flow control device,
wherein the flow control device outputs received liquid to individual hub structures at a predetermined flow rate, and
wherein the liquid received in the hub structures travels into soil within each planter attached to the hub structure.

22. The method of claim 21, further comprising providing liquid to the first tower, to a second tower, or to both through the control of a valve positioned on the liquid flowpath upstream of the central support structure of at least one tower.

23. The method according to claim 22, further comprising communicating between the first tower and the second tower to determine a relative position of each tower through a data collection device positioned above respective flow control devices on each tower.
